(19) United States
(12) Patent Application Publication
(10) Pub. No.: US 2023/0237255 A1
(43) Pub. Date: Jul. 27, 2023

(54) FORM GENERATION METHOD, APPARATUS, AND DEVICE, AND MEDIUM

(71) Applicant: Tencent Technology (Shenzhen) Company Limited, Shenzhen (CN)

(72) Inventors: Fei XIONG, Shenzhen (CN); Qiaoyun XU, Shenzhen (CN); Ye TIAN, Shenzhen (CN)

(73) Assignee: Tencent Technology (Shenzhen) Company Limited, Shenzhen (CN)

(21) Appl. No.: 18/128,367

(22) Filed: Mar. 30, 2023

Related U.S. Application Data
(63) Continuation of application No. PCT/CN2022/092381, filed on May 12, 2022.

(30) Foreign Application Priority Data
Jun. 16, 2021 (CN) 202110667240.7

(51) Int. Cl. G06F 40/174; G06F 40/205; G06F 40/103; G06F 40/30; G06F 3/0482

(52) U.S. Cl. CPC G06F 40/174; G06F 40/205; G06F 40/103; G06F 40/30; G06F 3/0482

(57) ABSTRACT

In a form generation method, a text entry interface is displayed. The text entry interface is configured to receive text content of a plurality of questions to be included in a questionnaire form. The text content of the plurality of questions to be included in the questionnaire form and entered in the text entry interface is received. The questionnaire form is generated according to the text content. The questionnaire form includes a plurality of questions that are determined based on parsing of the text content. Further, the questionnaire form is displayed.

### RELATED APPLICATIONS

This application is a continuation of International Application No. PCT/CN2022/092381, entitled “FORM GENERATION METHOD, APPARATUS AND DEVICE, AND MEDIUM” and filed on May 12, 2022, which claims priority to Chinese Patent Application No. 202110667240.7, entitled “FORM GENERATION METHOD, APPARATUS, AND DEVICE, AND MEDIUM” and filed on Jun. 16, 2021. The entire disclosures of the prior applications are hereby incorporated by reference in their entirety.

### FIELD OF THE TECHNOLOGY

This disclosure relates to the field of computer technologies, including to the field of artificial intelligence, and a form generation method, apparatus, and device, and a computer-readable storage medium.

### BACKGROUND OF THE DISCLOSURE

In many application scenarios (for example, a questionnaire scenario, a voting statistics scenario, or an information collection scenario), users often need to create collection forms to collect information. A collection form may be created by entering stem information of a question in a document application program with a collection form creation function.

Some document application programs provide users with a one-to-one question generation mode. That is, the user enters stem information corresponding to a question, and the document application program generates the question through transformation.

### SUMMARY

Embodiments of this disclosure include a form generation method, apparatus, and device, and a medium, which can automatically create a questionnaire form including a plurality of questions according to text content, reducing occupation of processing resources of a terminal while improving questionnaire form creation efficiency.

An embodiment of this disclosure provides a form generation method. In the method, a text entry interface is displayed. The text entry interface is configured to receive text content of a plurality of questions to be included in a questionnaire form. The text content of the plurality of questions to be included in the questionnaire form and entered in the text entry interface is received. The questionnaire form is generated according to the text content. The questionnaire form includes a plurality of questions that are determined based on parsing of the text content. Further, the questionnaire form is displayed.

An embodiment of this disclosure provides an information processing apparatus, such as a form generation apparatus, that includes processing circuitry. The processing circuitry is configured to display a text entry interface. The text entry interface is configured to receive text content of a plurality of questions to be included in a questionnaire form. The processing circuitry is configured to receive the text content of the plurality of questions to be included in the questionnaire form and entered in the text entry interface. The processing circuitry is configured to generate the questionnaire form according to the text content, the questionnaire form including a plurality of questions that are determined based on parsing of the text content. Further, the processing circuitry is configured to display the questionnaire form.

An embodiment of this disclosure also provides a form generation device. The device includes: a processor, configured to load and execute a computer program; and a computer-readable storage medium, the computer-readable storage medium storing the computer program, and the computer program, when executed by the processor, implementing the form generation method.

An embodiment of this disclosure also provides a non-transitory computer-readable storage medium. The computer-readable storage medium stores instructions which when executed by a processor cause the processor to implement the form generation method.

An embodiment of this disclosure also provides a computer program product or computer program. The computer program product or computer program includes a computer instruction. The computer instruction is stored in a computer-readable storage medium. A processor of a form generation device reads the computer instruction from the computer-readable storage medium. The processor executes the computer instruction, such that the form generation device performs the form generation method.

### BRIEF DESCRIPTION OF THE DRAWINGS

FIG. 1 is a schematic diagram of a form generation scenario according to some embodiments of this disclosure.

FIG. 2 is a schematic flowchart of a form generation method according to some embodiments of this disclosure.

FIG. 3a is a schematic diagram of a form editing interface according to some embodiments of this disclosure.

FIG. 3b is a schematic diagram of another form editing interface according to some embodiments of this disclosure.

FIG. 4a is a schematic flowchart of triggering displaying of an import window through an import entry according to some embodiments of this disclosure.

FIG. 4b is a schematic flowchart of triggering displaying of an import window through an import trigger operation according to some embodiments of this disclosure.

FIG. 5a is a schematic flowchart of entering a text content through copying and pasting according to some embodiments of this disclosure.

FIG. 5b is a schematic flowchart of entering text content in an import window according to some embodiments of this disclosure.

FIG. 5c is a schematic flowchart of entering text content in an import window through dragging according to some embodiments of this disclosure.

FIG. 6 is a schematic diagram of a questionnaire form according to some embodiments of this disclosure.

FIG. 7 is a schematic diagram of previewing a questionnaire form according to some embodiments of this disclosure.

FIG. 8 is a schematic diagram of publishing a questionnaire form according to some embodiments of this disclosure.

FIG. 9 is a schematic flowchart of a form generation method according to some embodiments of this disclosure.

FIG. 10 is a schematic diagram of collaboratively editing text content according to some embodiments of this disclosure.

FIG. 11a is a schematic diagram of selecting a target component from a component center region according to some embodiments of this disclosure.

FIG. 11b is a schematic diagram of deleting a question according to some embodiments of this disclosure.

FIG. 11c is a schematic diagram of modifying a question type according to some embodiments of this disclosure.

FIG. 11d is a schematic diagram of adjusting a display position of a question according to some embodiments of this disclosure.

FIG. 12 is a schematic timing diagram of executing a form generation manner according to some embodiments of this disclosure.

FIG. 13 is a schematic flowchart of executing a form generation manner according to some embodiments of this disclosure.

FIG. 14 is a schematic structural diagram of a classification system according to some embodiments of this disclosure.

FIG. 15 is a schematic structural diagram of a form generation apparatus according to some embodiments of this disclosure.

FIG. 16 is a schematic structural diagram of a form generation device according to some embodiments of this disclosure.

### DESCRIPTION OF EMBODIMENTS

Technical solutions in embodiments of this disclosure are described below in combination with the accompanying drawings. The described embodiments are not all but only part of embodiments of this disclosure. Other embodiments are within the scope of this disclosure.

Examples of technical terms and concepts used in embodiments of this disclosure will be briefly described below.

Embodiments of this disclosure may involve directions of natural language processing, machine learning, and the like in an artificial intelligence technology.

A questionnaire form may be referred to simply as a collection form, a form or text that may be used to collect information. The questionnaire form may include one or more questions. Therefore, after a user (that is, a completer who fills in the collection form) fills in or selects one or more questions in the questionnaire form, relevant information about the completer may be collected by collecting the completed questionnaire form. For example, in a freshman enrollment scenario, a questionnaire form may be made to collect basic information about freshmen. Collecting information through a questionnaire form improves information collection efficiency to some extent.

The one or more questions in the questionnaire form are usually represented in a form of a text. The text refers to a written representation form. The text may include a plurality of characters. One or more characters form a character string. The character may include at least one of the following: a Chinese character (that is, a Chinese character), an English character (that is, a letter), a number, and a punctuation mark (for example, a comma “,”, a full stop “.”, and square brackets “[ ]”). A plurality of questions in the questionnaire form may belong to the same or different question types. The question type may include but is not limited to a completion question type, a multiple-choice question type (for example, a single-answer question type or a multiple-answer question type), a true/false question type, and the like. Each question in the questionnaire form includes a stem portion and an answer portion. The stem portion includes a text for describing semantics of the question. The answer portion may include an answer option or an answer box. A type of the answer portion of the question is determined according to a question type of the question. For example, if a question in the questionnaire form belongs to the completion question type, an answer portion of the question includes an answer box, so that the completer fills in the answer box with an answer result for the question. For another example, if a question in the questionnaire form belongs to the single-answer question type, an answer portion of the question includes a plurality of answer options (for example, an answer option A, an answer option B, and an answer option C), so that the completer selects one of the plurality of answer options as an answer result. For another example, if a question in the questionnaire form belongs to the true/false question type, an answer portion of the question may include two answer options, so that the completer selects the answer option that is considered to be right by the completer from the two answer options. There are other examples.

A questionnaire form may be created through an application program (or referred to as an application for short) with a questionnaire form creation function. The application program refers to a computer program for completing one or more specific tasks. In embodiments of this disclosure, such an application program with the questionnaire form creation function is referred to as a document application program, for example, Tencent Docs. According to a running mode of the document application program, the document application program may include but is not limited to: (1) an application program installed and running in a terminal; (2) an installation-free application program, that is, an application program that can be used without download installation, which is also referred to commonly as an applet usually running in a client as a sub-program; (3) a web application program opened through a browser; and the like.

Some document application programs provide users with a one-to-one question generation mode. That is, the user enters stem information corresponding to a question, and the document application program generates the question through transformation. Consequently, the user needs to enter stem information for a plurality of times to create a collection table, making collection form creation efficiency low. Thus, it would be beneficial to improve the collection form creation efficiency and intelligence.

Based on the foregoing terms and concepts, embodiments of this disclosure include a form generation solution. According to this solution, displaying of an import window may be triggered in response to detecting an import trigger event in a process of creating a questionnaire form in a form editing interface. A user (that is, a creator of the questionnaire form) may enter text content required to create the questionnaire form in the import window. In this way, parsing processing may be performed on the text content to automatically create the questionnaire form including N questions, N being a positive integer greater than 1. In the foregoing process, the questionnaire form may be automatically created by entering the text content required to create the questionnaire form in the import window, so that the questionnaire form may be created simply and conveniently. In addition, the continuous text content is automatically split into the N questions, so that questionnaire form creation intelligence and efficiency are improved. Moreover, with regard to a questionnaire form including a plurality of questions, the terminal does not need to receive and then separately transform information entered by the user for each question and finally merge the plurality of questions, but may directly import text content corresponding to the plurality of questions to automatically create the questionnaire form including the plurality of questions. This reduces a plurality of receiving and transformation operations of the terminal. Therefore, occupation of processing resources of the terminal can be reduced, and processing efficiency of the terminal is improved.

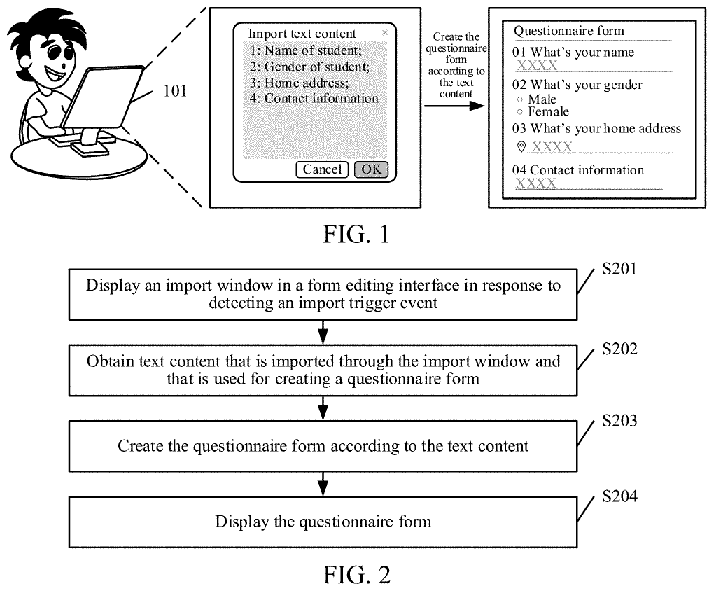

The form generation solution proposed in embodiments of this disclosure may be performed by a target terminal, for example performed by a document application program running in the target terminal. The target terminal may be any terminal. The terminal may include but is not limited to an intelligent device with a touch screen, for example, a smartphone (for example, an Android mobile phone or an iOS mobile phone), a tablet computer, a personal computer, a portable personal computer, a mobile Internet Device (MID), a smart television, an in-vehicle device, or a head-mounted device. A type of the terminal is not limited in embodiments of this disclosure. FIG. 1 is an exemplary schematic diagram of a form generation scenario. As shown in FIG. 1, if the target terminal is a personal computer 101, the creator may enter the text content required to create the questionnaire form in the import window displayed on the personal computer 101. If the text content is “1: Name of student; 2: Gender of student; 3: Home address; 4: Contact information.”, parsing processing may be performed on the text content to automatically create the questionnaire form. The questionnaire form includes a question 1, a question 2, a question 3, and a question 4. The question 1 obtained based on “1: Name of student” in the text content is of a completion question type. The question 2 obtained based on the “2: Gender of student” in the text content is of a multiple-choice question type. The question 3 obtained based on the “3: Home address” in the text content is of a geographic location question type (that is, address information may be automatically obtained by positioning through a global positioning system (GPS), and automatically written to a position of the question 3). The question 4 obtained based on the “4: Contact information” in the text content is of the completion question type. Based on the foregoing description, it can be seen that, according to the form generation solution mentioned in embodiments of this disclosure, the text content may be split into a plurality of questions, so as to implement intelligent and automatic creation of the questionnaire form.

Based on the form generation solution described above, embodiments of this disclosure propose a more specific form generation method. The following describes an exemplary form generation method proposed in embodiments of this disclosure in further detail in combination with the drawings.

FIG. 2 is a schematic flowchart of a form generation method according to some embodiments of this disclosure. The form generation method may be performed by a target terminal (for example, any terminal). The form generation method may include but is not limited to steps S201 to S204:

In step S201, display an import window in a form editing interface in response to detecting an import trigger event.

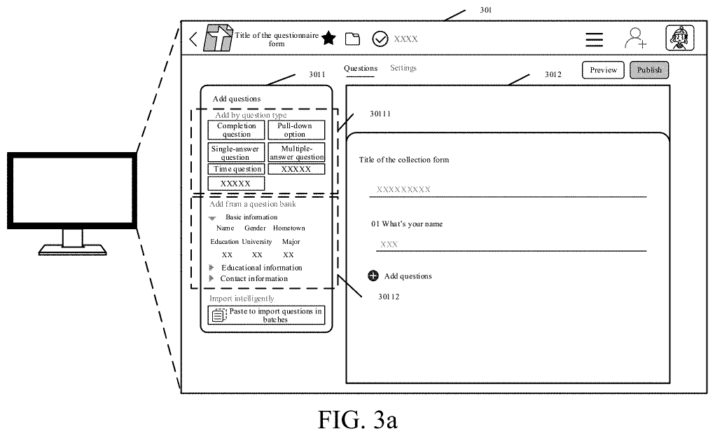

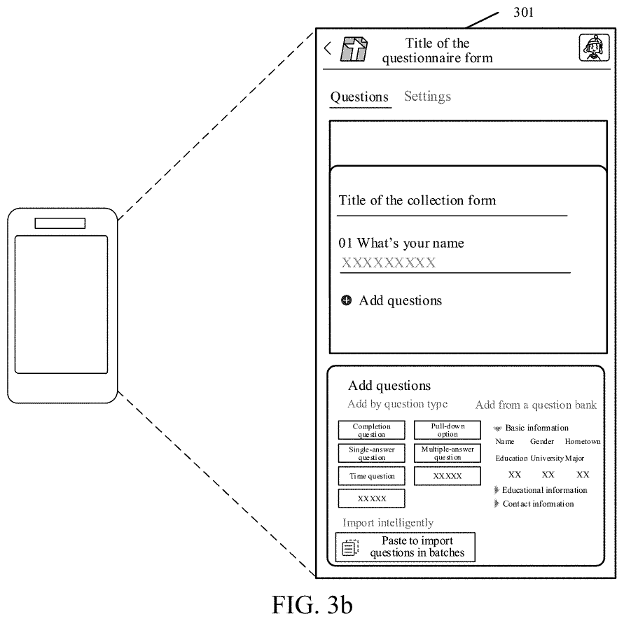

In some embodiments, the import trigger event is used to trigger the target terminal to display the import window, so as to receive text content imported by a user. When a creator opens and uses a document application program with a questionnaire form creation function, the form editing interface may be displayed in the document application program. As a user interface (UI), the form editing interface supports interaction with the user, so as to implement creation of a questionnaire form. FIG. 3a is an exemplary schematic diagram of the form editing interface. As shown in FIG. 3a, when the target terminal is a computer, a form editing interface 301 may be displayed in a display screen of the computer. The form editing interface 301 includes a component center region 3011 and a content display region 3012. The content display region 3012 may be used to display a created questionnaire form, for example used to display each question in the questionnaire form. A display area of the content display region 3012 is limited, so some of N questions in the questionnaire form may be hidden. In this case, the content display region 3012 may include a sliding axis, and the sliding axis may be operated to display the hidden questions in a sliding manner. In addition to displaying the questions in the content display region 3012 by sliding the sliding axis, the questions in the content display region 3012 may also be displayed in the sliding manner by pressing any position in the content display region 3012 (or the form editing interface 301). This is not limited in the embodiments of this disclosure.

The component center region 3011 includes at least one candidate component, and one candidate component corresponds to one question type template. For example, the component center region 3011 includes a completion component (displayed as “Completion question” in FIG. 3a), the completion component corresponds to a completion question type, and a completion question type template is configured for the completion question type. The at least one candidate component in the component center region 3011 may be divided according to different rules. For example, the at least one candidate component is divided into the completion component, a single-answer component, a multiple-answer component, a pull-down component, and the like according to a question type. In another example, the at least one candidate component may be divided into a basic information component (for example, a name component, a gender component, or a hometown component), an education information component, a contact information component, and the like according to content in the question. The candidate component divided according to the same rule may be displayed in a region in a centralized manner. For example, the candidate component divided according to the question type may be displayed in a region 30111 of the component center region 3011, and the candidate component divided according to the content in the question may be displayed in a region 30112 of the component center region 3011 in the centralized manner. In this way, the creator may quickly find a required candidate component. After finding the required candidate component from the component center region 3011, the creator may load the candidate component to the content display region 3012 to implement addition of a question required to create the questionnaire form. An implementation of adding a new question through the component center region 3011 will be described in further detail in the following embodiments.

It is to be noted that a style of the form editing interface is described above by using an example in which the target terminal is the computer. When the target terminal is a smartphone, an exemplary schematic diagram of the form editing interface may refer to FIG. 3b. As shown in FIG. 3b, when the smartphone displays the form editing interface, the form editing interface includes a component center region and a content display region, but the style adaptively changes with a display screen of the smartphone. The style of the form editing interface displayed on the smartphone is not described herein in detail. For ease of description, the following describes each interface displayed on the target terminal by using the example in which the target terminal is the computer, and this does not constitute a limitation on the embodiments of this disclosure.

If there is the import trigger event in the form editing interface, it indicates that the creator intends to add a question to the questionnaire form by entering text content. In this case, the import window is displayed, so that the creator may enter text content corresponding to a plurality of questions required to create the questionnaire form in the import window at one time to implement quick creation of a text form. The import trigger event may be generated in, but not limited to, the following manners.

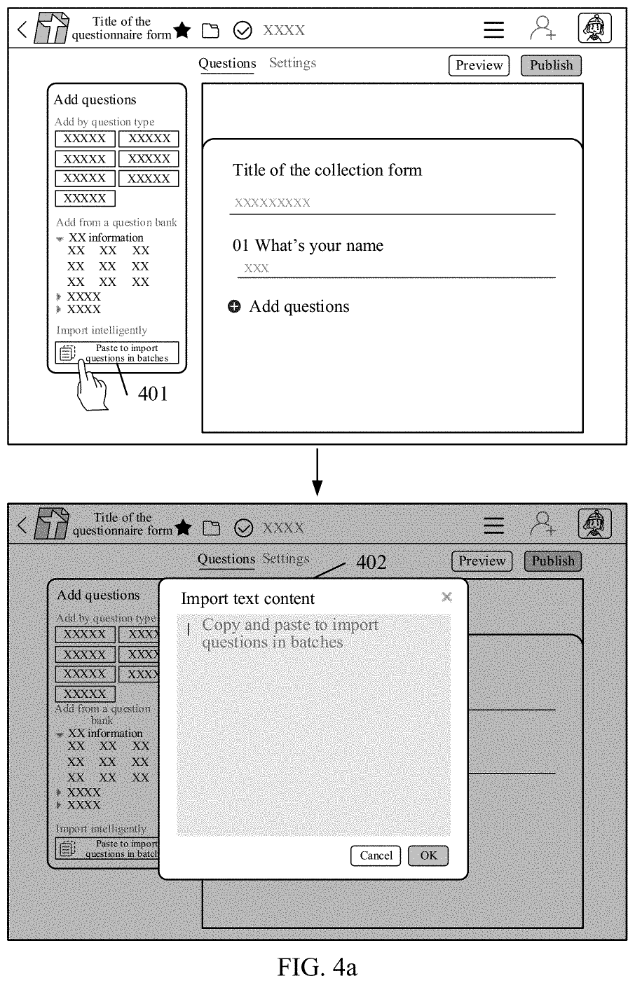

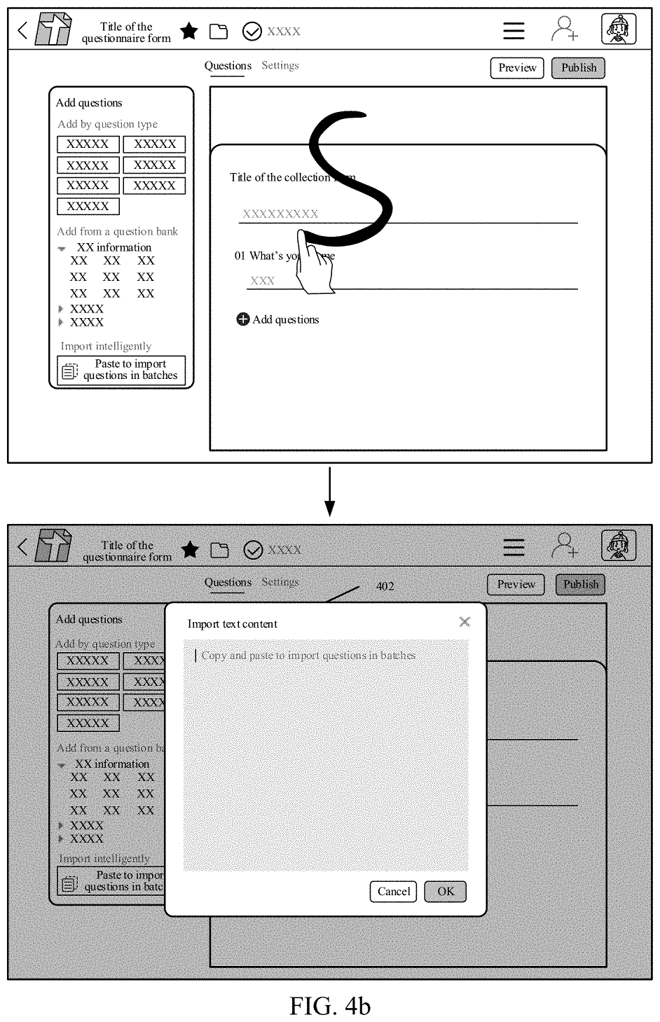

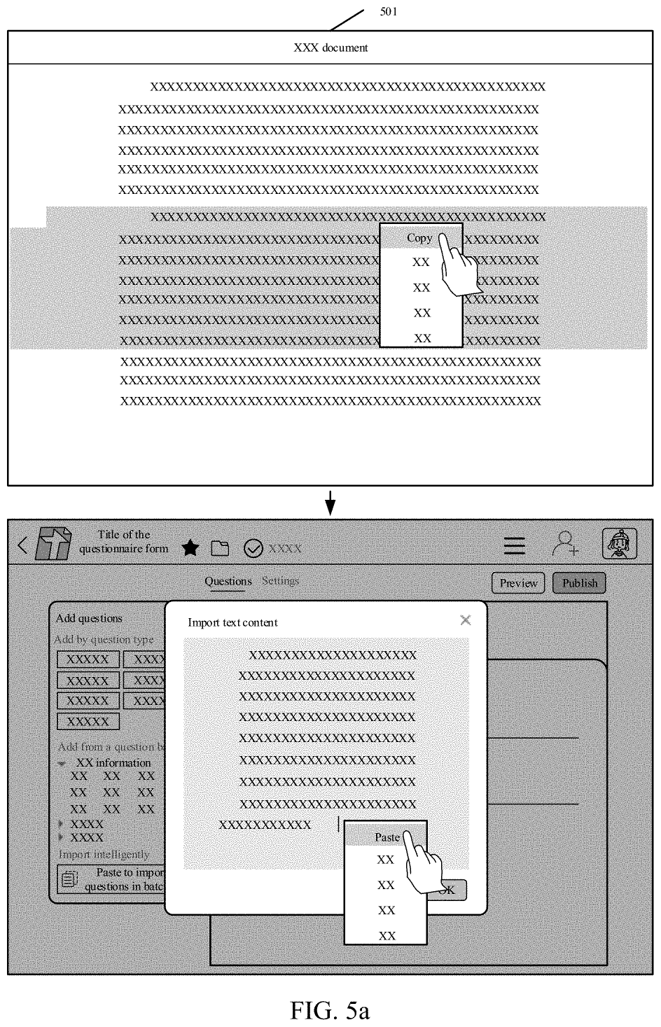

(1) The import trigger event may be generated by triggering an import entry set in the form editing interface. For example, the import entry is set in the form editing interface, and the import trigger event is generated in a case that the import entry is triggered. FIG. 4a is a schematic flowchart of triggering displaying of the import window through the import entry. As shown in FIG. 4a, an import entry 401 is set in the form editing interface. When the import entry 401 is triggered, it indicates that the creator intends to enter text content to create the questionnaire form. In this case, an import window 402 is displayed. The creator may enter the text content in the import window 402 to create the questionnaire form. The import window 402 shown in FIG. 4a is displayed overlaying the form editing interface. In another implementation, the import window 402 may be displayed on the screen as an independent interface. A display form of the import window 402 is not limited in the embodiments of this disclosure.

(2) The import trigger event may be generated through an import trigger operation. In an example, the import trigger event is generated in a case that there is the import trigger operation in the form editing interface. The import trigger operation may include at least one of the following: a gesture operation, an audio signal input operation, a vibration operation, and the like. The gesture operation may refer to an operation of entering a gesture capable of generating the import trigger event in the form editing interface, and the gesture is usually set in advance. For example, a gesture capable of triggering displaying of the import window is set to include an S-shaped gesture, an L-shaped gesture, or a pull-down gesture. The audio signal input operation may refer to an operation of inputting a voice audio signal capable of generating the import trigger event. For example, the voice audio signal in an environment where the creator is located may be acquired through a microphone of the target terminal, and displaying of the import window may be triggered when the input voice audio signal instructs generation of the import trigger event. The vibration operation may refer to an operation of generating the import trigger event when the target terminal is shaken. For example, if the target terminal is the smartphone, when the smartphone is shaken in a horizontal direction (or top and down, or in any direction), the smartphone may vibrate, that is, the import trigger operation is generated. In this case, displaying of the import window is triggered. The above description gives only some exemplary import trigger operations, and other appropriate import trigger operations are also supported in the embodiments of this disclosure.

The following describes an example flowchart of triggering displaying of the import window through the import trigger operation by using an example in which the import trigger operation is the gesture operation, the gesture operation including entering the S-shaped gesture on the form editing interface. As shown in FIG. 4b, when the creator performs the gesture operation of entering the S-shaped gesture at any position or in a display region on the form editing interface, it indicates that the creator intends to open the import window. In this case, displaying of the import window is triggered in response to the S-shaped gesture operation. It may be understood that the gesture for triggering displaying of the import window is preset, and displaying of the import window may be triggered only when a gesture entered by the creator matches the preset gesture. In addition, a custom gesture of the creator is supported in the embodiments of this disclosure, so that only the creator knows the gesture for opening the import window. In this way, a problem of creating some important questionnaire forms by illegal use of accounts of others to collect information may be solved, and information security is protected to some extent.

It is to be noted that before displaying of the import window is triggered, the creator may add a question to the form editing interface, so that the finally generated questionnaire form includes not only the question automatically generated according to the text content but also the custom question of the creator. For example, the custom question may be pulled from the component center region. This part of content will be described in the following embodiments.

In step S202, obtain the text content that is imported through the import window and that is used for creating the questionnaire form.

In embodiments of this disclosure, the creator may enter the text content required to create the questionnaire form in the import window. The text content may include a plurality of character strings, and each character string may include one or more characters. For example, if the text content is “1: Name of student; 2: Gender of student”, the text content includes a character string “1: Name of student;” and a character string “2: Gender of student”, and the character string “1: Name of student,” includes a character “1”, a character “:”, a character “name”, and the like. A character may also be referred to as a word, and a character string formed by a plurality of characters may also be referred to as a phrase. Entering of the text content in the import window may include but is not limited to the following several implementations.

1: The text content is entered through an input control. In an exemplary implementation, the input control is set in the import window, and the input control may be invoked to enter the text content in the import window. The input control may refer to a virtual keyboard displayed in the display screen of the target terminal. The virtual keyboard may be displayed over the form editing interface or in the form editing interface. Therefore, the creator may edit the text content into the import window through the virtual keyboard. The target terminal also supports an external physical keyboard to enter the text content in the import window. A form of the input control is not limited in the embodiments of this disclosure.

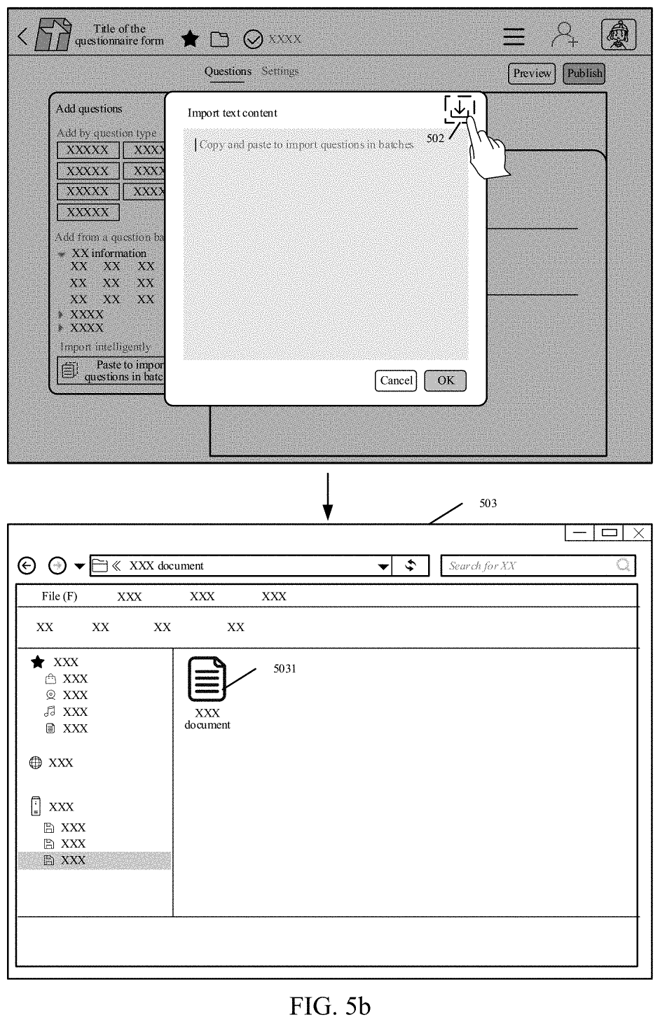

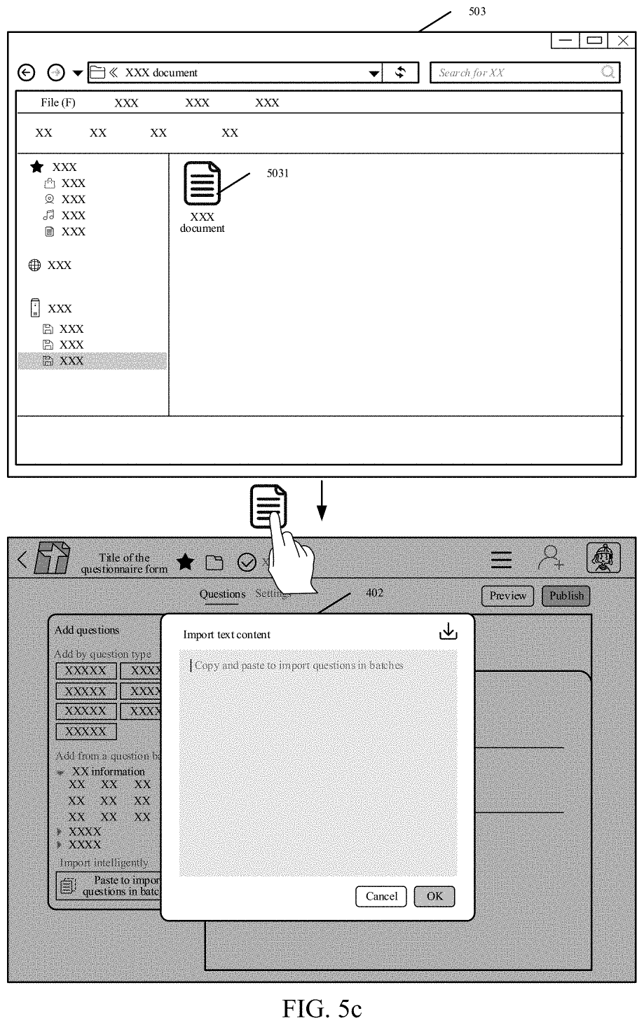

2: The text content is entered through copying and pasting. In an exemplary implementation, the text content may be in a document. In this case, the text content may be copied from the document and pasted in the import window, to implement entering of the text content to the import window. The document herein may refer to a document stored in a local storage space of the target terminal, or may refer to a document stored in the Internet. FIG. 5a is a schematic flowchart of entering the text content through copying and pasting. As shown in FIG. 5a, when the document is opened in the target terminal, a document page 501 may be displayed, and document content in the document is displayed in the document page 501. The text content may be all or part of document content in the document. After the text content is copied from the document, the copied text content may be pasted to the import window, to implement entering of the text content to the import window.

3: The text content is entered through loading. In an exemplary implementation, the text content may be in a document. In this case, the document may be loaded to the import window to load the text content in the document to the import window. Loading may include at least one of the following: dragging, importing through an import control, importing through a gesture operation, and importing through an audio signal. In other words, the document may be imported to the import window to load the text content in the document to the import window. This can quickly implement addition of the text content to the import window, and ensure simplicity and convenience for operation.

(1) Dragging may refer to dragging the document from a window that the document belongs to (for example, a document window) to the import window and releasing the document to implement loading of the document to the import window and further implement import of the text content in the document to the import window. FIG. 5c is a schematic flowchart of entering the text content in the import window through dragging. As shown in FIG. 5c, a document window 503 includes a document 5031, and the document 5031 includes the text content. In this case, the document 5031 may be dragged from the document window 503 to the import window 402 to load the document 5031 to the import window 402 and further implement entering of the text content in the import window 402. (2) Importing through the import control may refer to loading the document into the import window by triggering a control for importing a document. FIG. 5b is a schematic flowchart of entering the text content in the import window by loading the document through the import control. As shown in FIG. 5b, an import control 502 is displayed in the import window. When the import control 502 is triggered, a file window 503 may be output. The file window 503 includes a plurality of candidate documents stored in a local storage space of the target terminal. The plurality of candidate documents include a document including the text content, for example, the document 5031. When the document 5031 is triggered, the document 5031 is imported to the window 402, and the text content in the document 5031 is displayed in the import window 402. (3) Importing through the gesture operation may refer to performing a gesture operation of drawing a preset shape in the import window to load the document to the import window. For example, a gesture operation corresponding to a document 1 is a gesture operation of drawing a W in the import window, and a gesture operation corresponding to a document 2 is a gesture operation of drawing a Z in the import window. In this case, when the gesture operation of drawing a W is detected in the import window, the document 1 is determined to be loaded to the import window to further implement importing of the text content in the document 1 to the import window. When the gesture operation of drawing a Z is detected in the import window, the document 2 is determined to be loaded to the import window to further implement importing of text content in the document 2 to the import window. A document window may also be triggered to be opened through a gesture operation, the document window including a plurality of documents, and then one of the plurality of documents is selected for loading according to a selection operation of the user. This is not limited in the embodiments of this disclosure. (4) Importing through the audio signal may refer to acquiring the audio signal in a current environment through the microphone of the target terminal, and if the audio signal instructs a target document (for example, any document) to be imported, importing the target document to the import window. For example, a first audio signal acquired at a first moment instructs a document window to be opened, and a second audio signal acquired at a second moment instructs the target document in the document window to be loaded to the import window. In this case, the target document may be imported to the import window step by step according to the first audio signal and the second audio signal. The first moment is earlier than the second moment. For another example, an audio signal acquired at any moment instructs the target document to be loaded. In this case, the target document may be loaded to the import window at one time according to the audio signal.

The above provides only several exemplary implementations of entering the text content in the import window, and does not constitute a limitation on the implementation of entering the text content in the embodiments of this disclosure.

In step S203, create the questionnaire form according to the text content.

In step S204, display the questionnaire form.

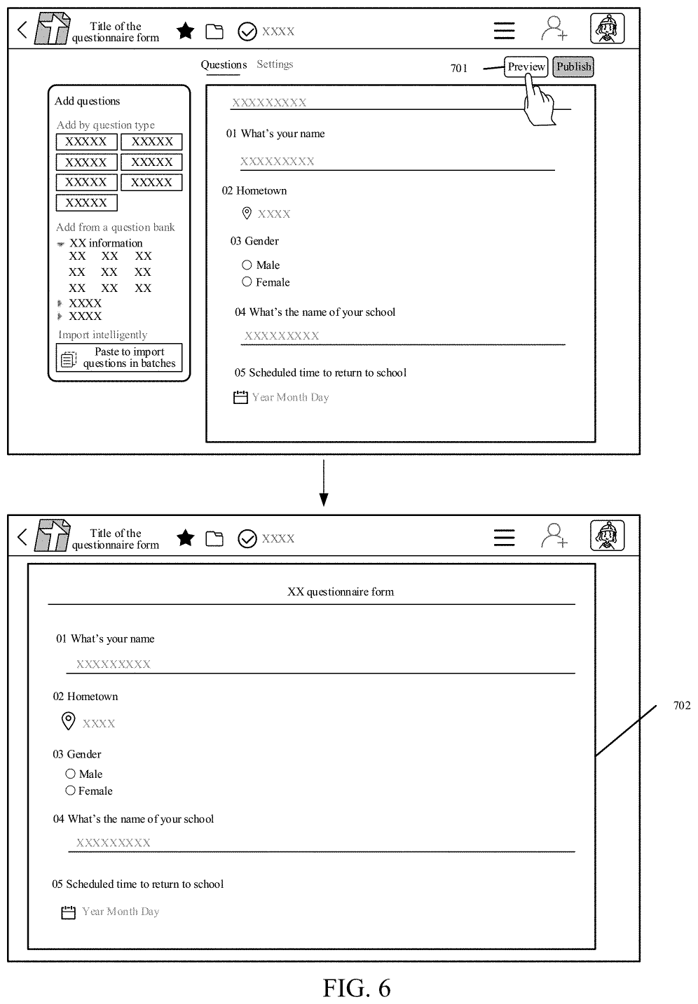

In steps S203 to S204, if a confirmation operation is detected in the import window (for example, an OK control in the import window is selected), that is, the text content entered in the import window is determined to be used as content for creating the questionnaire form, the questionnaire form may be created according to the text content. The questionnaire form is displayed in the target terminal. In an example, the questionnaire form is displayed in the form editing interface, that is, the questionnaire form is displayed in the content display region in the form editing interface. The questionnaire form includes the N questions, and the N questions in the questionnaire form may be questions of the same question type, or may be questions of different question types. For example, all of the N questions in the questionnaire form are questions of the completion question type. For another example, P questions in the questionnaire form are questions of a true/false question type, and N-P questions are questions of the completion question type, P being an integer greater than 0 and less than or equal to N. FIG. 6 is an exemplary schematic diagram of the questionnaire form. As shown in FIG. 6, it is assumed that the text content entered in the import window is “1: Name; 2: Address; 3: Gender; 4: School name; 5: Time to return to school”. When the OK control in the import window is selected, the questionnaire form may be generated according to the text content, and the generated questionnaire form may be displayed in the content display region of the form editing interface. In this case, five questions obtained by performing parsing processing on the text content are displayed in the content display region. In addition, the five questions in the created questionnaire form are questions of different question types. As shown in FIG. 6, in the five questions in the questionnaire form, a question 1 and a question 4 are questions of the completion question type, a question 2 is a question of a geographic location question type, a question 3 is a question of the true/false question type, and a question 5 is a question of a time question type. An expression (for example, content of a stem) of the question may not be completely the same as the text content, but has the same meaning. For example, the text content “Name” and the corresponding question “What's your name” have different expressions, but substantially ask for the name of a completer.

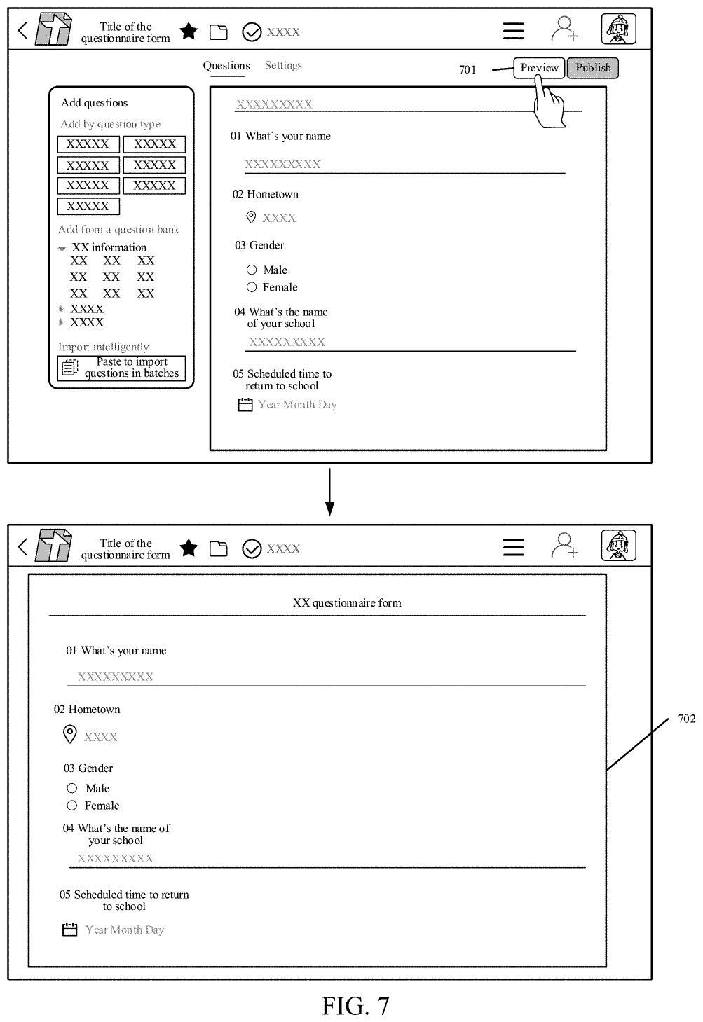

In addition, the creator may preview the created questionnaire form after creating the questionnaire form in the embodiments of this disclosure. This helps the creator browse the questionnaire form from the perspective of the completer, meets a preview requirement of the creator for the questionnaire form, and improves the quality of the questionnaire form. In an exemplary implementation, the form editing interface includes a preview control. If the preview control is selected, it indicates that the creator intends to preview the questionnaire form. In this case, a preview interface is displayed, and the questionnaire form is displayed in the preview interface. FIG. 7 is an exemplary schematic diagram of previewing the questionnaire form. As shown in FIG. 7, a preview control 701 is displayed in the form editing interface. When the preview control 701 is triggered, a preview interface 702 may be displayed, and the questionnaire form is displayed in the preview interface 702. In an example, the N questions in the questionnaire form are displayed. It may be understood that when the N questions cannot be all displayed in the preview interface, that is, some questions are hidden because of a limited length of the display screen, in the embodiments of this disclosure, the N questions may be displayed in the sliding manner in the preview interface, so as to implement displaying of the hidden questions.

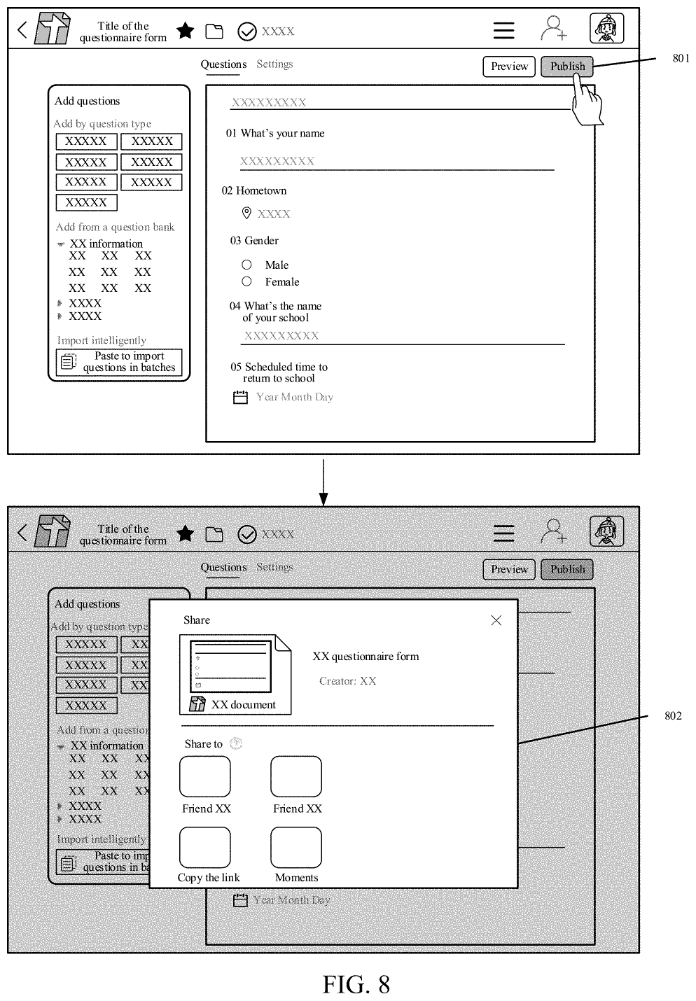

In embodiments of this disclosure, the creator may publish the questionnaire form after creating the questionnaire form, such that a receiver of the questionnaire form may fill in the questionnaire form, to further implement collection of information about the completer. In an exemplary implementation, the form editing interface includes a publishing option, and the questionnaire form is published when there is a selection operation on the publishing option. Publishing the questionnaire form may include but is not limited to sharing the questionnaire form to a social information page (for example, Moments or an information space), sending the questionnaire form to another user (for example, a user who is a friend), generating a link address of the questionnaire form (for example, generating a two-dimensional code, or copying a link), and the like. FIG. 8 is an exemplary schematic diagram of publishing the questionnaire form. As shown in FIG. 8, there is a publishing option 801 in the form editing interface. When the publishing option 801 is triggered, it indicates that the creator intends to publish the questionnaire form. In this case, a sharing window 802 is output. The sharing window 802 includes an identifier of at least one sharing object. The identifier of the at least one sharing object may include but is not limited to a user identifier of a specific user, a page identifier of a social information page, an entry identifier of a generated link, and the like. When the creator selects the identifier of any sharing object, the questionnaire form may be published to a page indicated by the selected identifier. For example, if the creator selects the page identifier of the social information page, the questionnaire form may be displayed in the social information page. It is to be noted that FIG. 8 shows only an exemplary implementation of publishing the questionnaire form, and another possible implementation of publishing the questionnaire form is also supported in the embodiments of this disclosure.

In embodiments of this disclosure, the import window may be displayed in response to the import trigger event, the text content required to create the questionnaire form is entered in the import window, and then the questionnaire form including the N questions is automatically created according to the text content. In the foregoing solution, the questionnaire form may be automatically created by entering the text content required to create the questionnaire form in the import window, so that the questionnaire form may be created simply and conveniently. In addition, the continuous text content is automatically split into the N questions, so that questionnaire form creation intelligence and efficiency are improved.

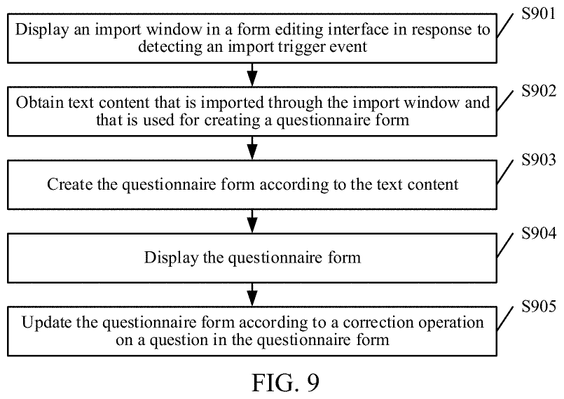

FIG. 9 is a schematic flowchart of a form generation method according to some embodiments of this disclosure. The form generation method may be performed by a target terminal (for example, any terminal). The form generation method may include but is not limited to steps S901 to S905:

In step S901, display an import window in response to detecting an import trigger event in a form editing interface.

In step S902, obtain text content that is imported through the import window and that is used for creating a questionnaire form.

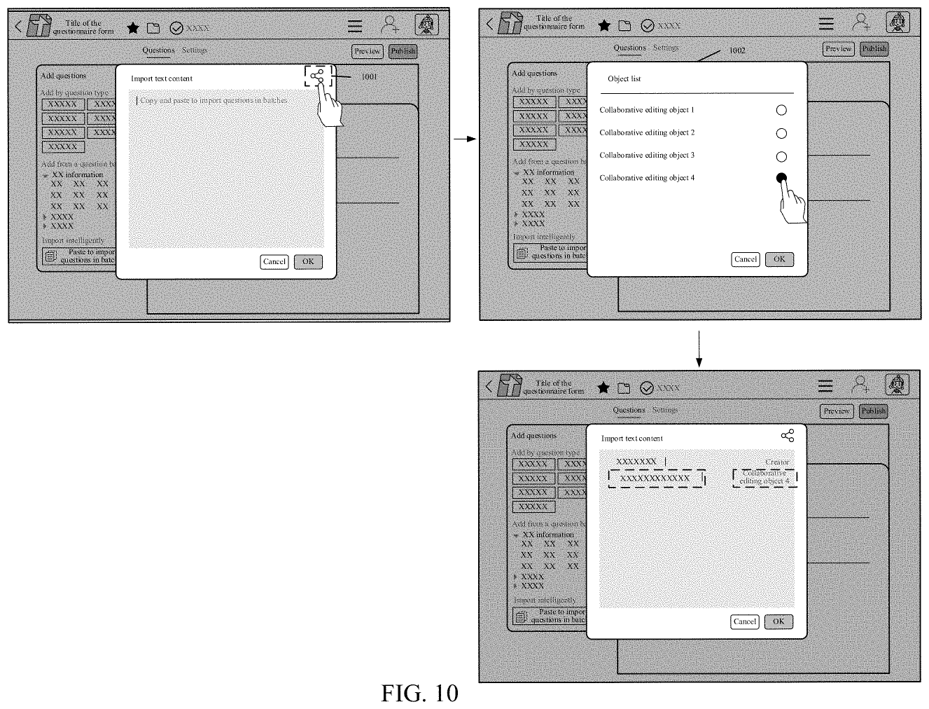

In embodiments of this disclosure, a plurality of users may collaboratively enter the text content. In other words, the plurality of users may enter the text content in import windows on terminals respectively used by the users, so as to implement multi-person collaborative creation of the questionnaire form. In an exemplary implementation, an object list is displayed in response to detecting a collaborative editing trigger operation on the text content, the object list including an identifier of at least one collaborative editing object. One or more identifiers are selected from the object list, and the text content in the import window is transmitted to the selected collaborative editing object for collaborative editing. The text content in the import window is updated according to a collaborative editing result. The collaborative editing trigger operation is used to trigger displaying of the object list. The object list includes an identifier of a collaborative editing object that a user of the target terminal intends to add. FIG. 10 is an exemplary schematic diagram of collaboratively editing the text content. As shown in FIG. 10, a collaborative editing entry 1001 is displayed in the import window. When the collaborative editing entry 1001 is triggered, it indicates that the creator intends to add a collaborative editing object to create the questionnaire form together. In this case, an object list 1002 is output. The object list 1002 includes an identifier of at least one collaborative editing object, for example, includes an identifier of a collaborative editing object 1, an identifier of a collaborative editing object 2, an identifier of a collaborative editing object 3, and an identifier of a collaborative editing object 4. If the creator selects the identifier of the collaborative editing object 4, current text content in the import window is sent to the collaborative editing object 4, such that the collaborative editing object 4 may perform collaborative editing based on the current text content. The text content in the import window is updated according to a collaborative editing result. The collaborative editing result may include the text content entered by the creator and the collaborative editing object respectively.

In embodiments of this disclosure, the text content and the identifier of the corresponding collaborative editing object may also be displayed in real time in the import window, such that a plurality of collaborative editing objects and the creator may more clearly know about, in their own import windows, the text content edited by each collaborative editing object. For example, the creator and the collaborative editing object 4 simultaneously enter text content in the import windows: the creator enters text content 1 in the import window, and the collaborative editing object 4 enters text content 2 in the import window. In this case, an identifier of the creator may be displayed in a display region occupied by the text content 1, and the identifier of the collaborative editing object 4 may be displayed in a display region occupied by the text content 2. This helps each user entering text content clearly know about a correspondence between text content and a collaborative editing object.

In step S903, create the questionnaire form according to the text content.

In step S904, display the questionnaire form.

For exemplary implementations of steps S901 to S904 reference may be made to the related descriptions about the exemplary implementations shown in steps S201 to S204 in the embodiment shown in FIG. 2.

In embodiments of this disclosure, a plurality of users may collaboratively edit the questionnaire form. In an exemplary implementation, an object list is displayed in response to detecting a collaborative editing trigger operation on the questionnaire form, the object list including an identifier of at least one collaborative editing object. One or more identifiers are selected from the object list, and the questionnaire form is transmitted to the selected collaborative editing object for collaborative editing. The questionnaire form is updated according to a collaborative editing result. For an exemplary implementation of collaboratively editing the questionnaire form, reference may be made to the related descriptions about multi-person collaborative entering of the text content shown in FIG. 10.

In step S905, update the questionnaire form according to a correction operation on a question in the questionnaire form.

In embodiments of this disclosure, after the questionnaire form is created based on steps S901 to S904, the questionnaire form may further be corrected to implement perfection of the questionnaire form, such that a corrected questionnaire form meets a requirement of the creator. In an exemplary implementation, the questionnaire form may be updated according to the correction operation on the question in the questionnaire form. The correction operation includes at least one of the following: increasing or decreasing a quantity of questions in the questionnaire form, where increasing/decreasing may refer to adding a question to the questionnaire form to increase the quantity of questions in the questionnaire form, or deleting a question in the questionnaire form to decrease the quantity of questions in the questionnaire form; modifying a question type of the question in the questionnaire form; adjusting a display position of the question in the questionnaire form; and the like. The following briefly describes the above several correction operations on the questionnaire form.

1: The correction operation includes increasing the quantity of questions in the questionnaire form. In an example, a target component may be selected from a component center region of the form editing interface according to a component selection operation, the target component being any one of at least one candidate component. A target question type template corresponding to the target component is added to the questionnaire form. The questionnaire form is updated according to a question editing operation on the target question type template, an updated questionnaire form including a target question obtained after the question editing operation is performed on the target question type template. The component selection operation includes at least one of the following: a dragging operation of dragging the target component from the component center region to the questionnaire form, or a trigger operation performed on the target component in the component center region. In other words, in embodiments of this disclosure, the target component may be selected from the component center region, and the target question corresponding to the target component is added to the questionnaire form.

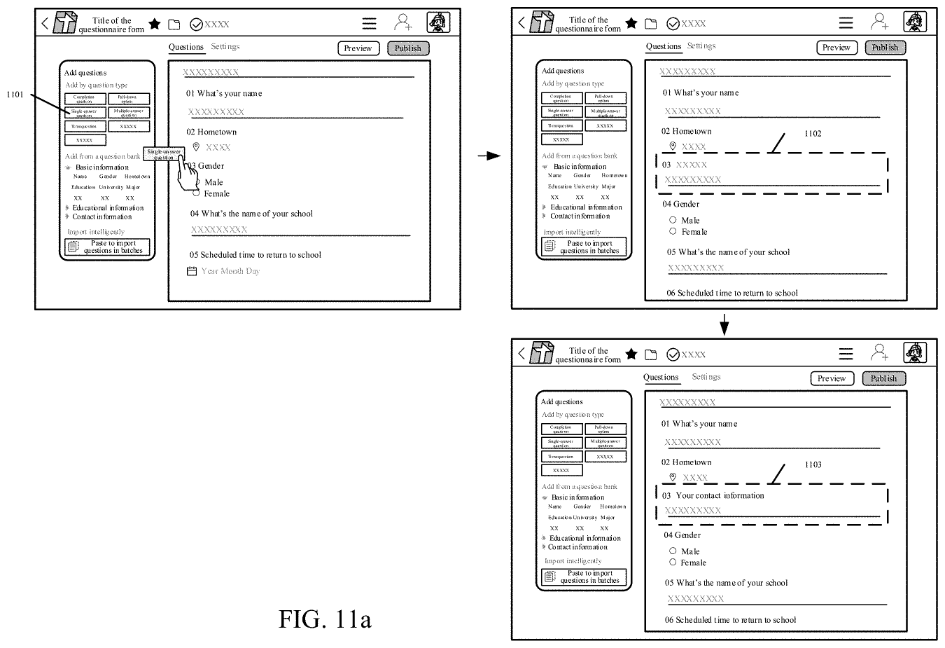

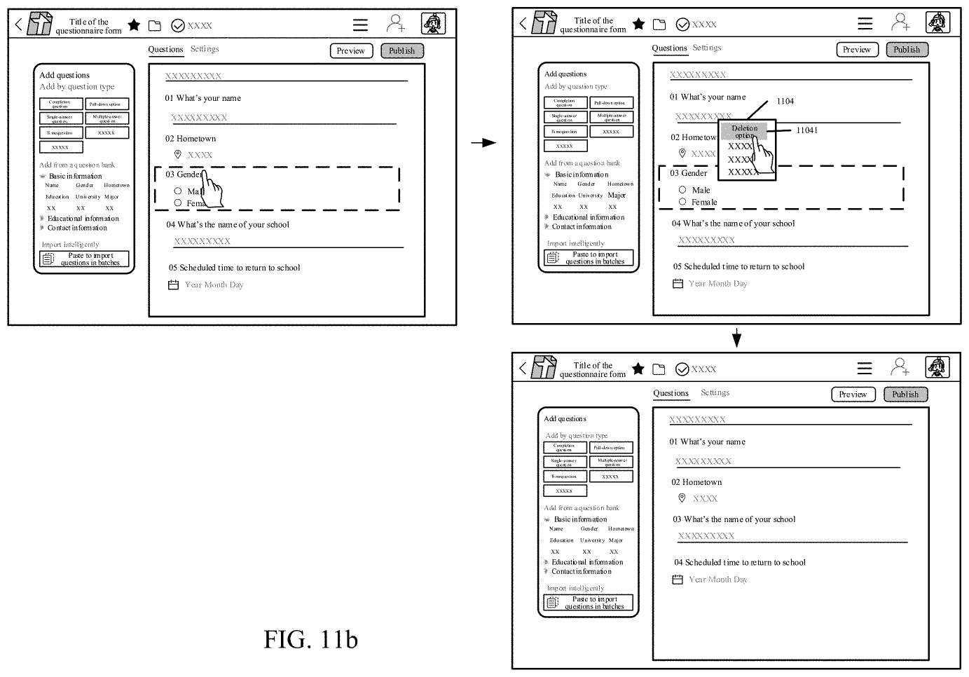

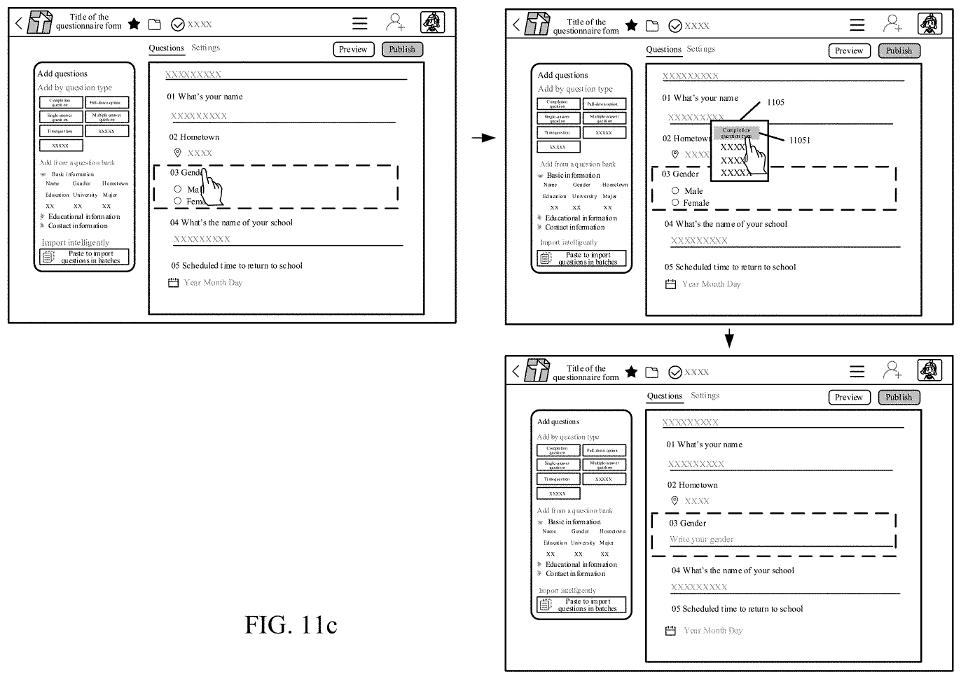

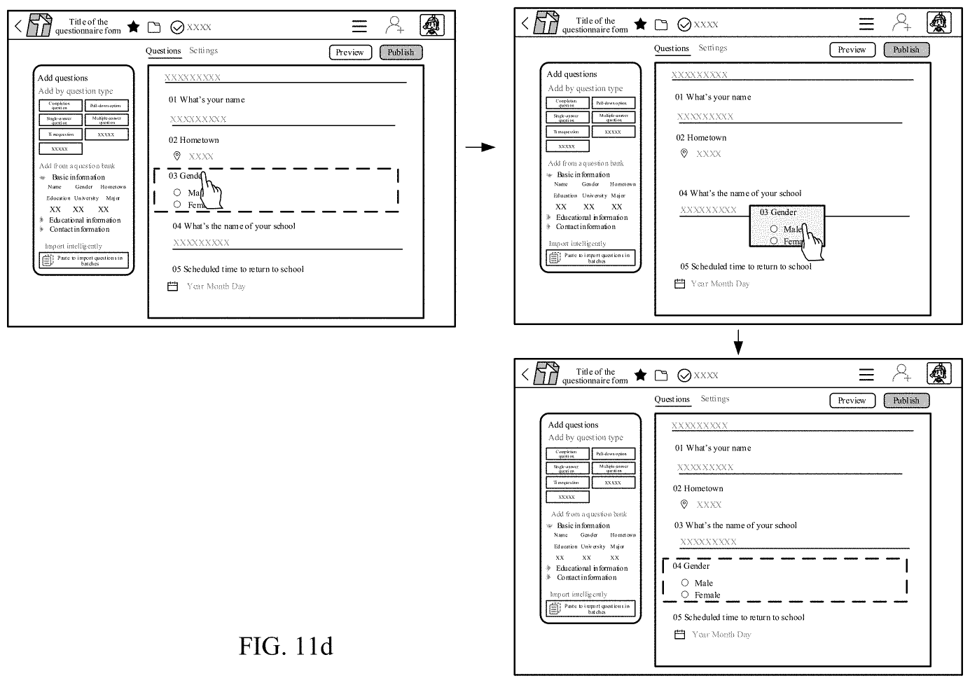

Referring to FIG. 11a, FIG. 11a is a schematic diagram of selecting a target component from a component center region according to some embodiments of this disclosure. As shown in FIG. 11a, the component center region includes the at least one candidate component, and one candidate component corresponds to one question type template. For example, a candidate component 1101 corresponds to a single-answer question type. When the creator selects the candidate component 1101 in the component center region, and drags the candidate component 1101 from the component center region to the questionnaire form, the candidate component 1101 is determined as the target component. In this case, a target question type template 1102 corresponding to the candidate component 1101 is placed in the questionnaire form. For example, the target question type template 1102 is a single-answer question type template. The creator may perform a question editing operation on the single-answer question type template, that is, edit a title of a question, such that the target question type template forms a complete target question 1103. In this way, the updated questionnaire form includes the target question. In the foregoing process, in the process in which the candidate component 1101 is dragged to the questionnaire form, the candidate component 1101 may be specifically placed at a display position where the dragging operation ends. As shown in FIG. 11a, if the dragging operation ends (that is, the candidate component 1101 is released) at a display position after a question 2 in the original questionnaire form after the candidate component 1101 is dragged to the questionnaire form, the target question type template 1102 corresponding to the candidate component 1101 is placed at a display position between the question 2 and a question 3 in the original questionnaire form. Moreover, the question 3 and a question after the question 3 are sequentially moved backwards, and 1 is added to a serial number of each question. For example, the question 3 in the original questionnaire form becomes a question 4. This may help the creator place the target component at a display position preferred by the creator, and improve an ability of the creator in customizing a question.

2: The correction operation includes deleting the question in the questionnaire form. In an example, a to-be-deleted question may be triggered (for example, pressed for long or double-tapped) in the questionnaire form. In this case, a prompt window is output. The prompt window includes a deletion option. After the deletion option is selected, the selected question may be deleted from the questionnaire form, an updated questionnaire form does not include the selected question, and a serial number of a question in the questionnaire form may change accordingly. This implementation of deleting the question may refer to FIG. 11b. As shown in FIG. 11b, if the to-be-deleted question is the question 3 in the questionnaire form, when the question 3 is triggered, a prompt window 1104 may be output. The prompt window 1104 includes a deletion option 11041. When the deletion option 11041 is selected, the question 3 is deleted from the questionnaire form. In addition, after the question 3 is deleted, a serial number 4 of the question 4 in the questionnaire form changes to a serial number 3, a serial number 5 of a question 5 changes to the serial number 4, . . . , and the like.

The above gives only an exemplary implementation of deleting the question from the questionnaire form. In another implementation, the to-be-deleted question may be dragged to a blank region to implement deletion of the to-be-deleted question from the questionnaire form; the to-be-deleted question is double-tapped to implement deletion of the question from the questionnaire form; or the like. A specific implementation of deleting the question from the questionnaire form is not limited in the embodiments of this disclosure.

3: The correction operation includes modifying the question type of the question in the questionnaire form. For example, a completion question type is modified to a true/false question type, and a location information question type is modified to the completion question type. For example, if the text content includes “home address”, parsing processing may be performed on the text content to obtain that a question type of a question corresponding to the text content is the location information question type. The location information question type supports automatically filling in the question by using current location information of a completer as an answer through a positioning system. However, it may be understood that a current location of the completer may not be a location indicated by the home address. Considering the foregoing similar uncertain factor, the creator may modify the location information question type into the completion question type after creating the questionnaire form, so that the completer may fill in actual home address information as required.

The correction operation of modifying the question in the questionnaire form may include but is not limited to the following: a question whose question type is to be modified may be triggered (for example, pressed for long or double-tapped) in the questionnaire form. In this case, a question type window is output. The question type window includes components corresponding to a plurality of question types. The creator may select any question type from the question type window, and then modify, in the questionnaire form, the original question type into the any question type selected from the question type window, so as to implement modification of the question type of the question in the questionnaire form. FIG. 11c is an exemplary schematic diagram of modifying the question type. As shown in FIG. 11c, if the question whose question type is to be modified is the question 3 in the questionnaire form, when the question 3 is triggered, a question type window 1105 may be output. The question type window 1105 includes a component corresponding to at least one question type, for example, a component 11051 corresponding to the completion question type. When the component 11051 is selected, a question type of the question 3 is modified into the completion question type in the questionnaire form.

(1) According to different question types of triggered questions, the components corresponding to the plurality of question types displayed in the question type window are different. For example, the question whose question type is to be modified includes a character string “Gender”, a question type that matches the question may include the completion question type, a multiple-choice question type, the true/false question type, and the like, and a question type that does not match the question may include the location information question type, the time question type, and the like. In this case, when the question is triggered, the question type window may include a component corresponding to the question type that matches the question (for example, a component corresponding to the completion question type, a component corresponding to the multiple-choice question type, and a component corresponding to the true/false question type), and does not include a component corresponding to the question type that does not match the question (for example, a component corresponding to the location information question type and a component corresponding to the time question type). (2) The foregoing implementation of modifying the question type is merely an exemplary description, and a specific implementation of modifying the question type is not limited in the embodiments of this disclosure.

4: The correction operation includes adjusting the display position of the question in the questionnaire form. For example, display positions of a first question and a second question in the questionnaire form are swapped; in another example, a first question in the questionnaire form is adjusted to be after a third question; and the like. The correction operation of adjusting the display position of the question may include the following: if a question 1 is at a first display position in the questionnaire form, the question 1 being in an unmovable state at this moment (a display position of the question 1 cannot be changed in this state), and the question 1 now needs to be adjusted to a second display position in the questionnaire form, the first display position being different from the second display position. In this case, the question 1 (or any position of a display region occupied by the question 1) may be triggered (for example, pressed for long). After the state of the question 1 is changed to a movable state (the display position of the question 1 can be changed in this state), the question 1 is dragged from the first display position to the second display position, so as to implement adjustment of the question 1 from the first display position to the second display position. In addition, in embodiments of this disclosure, after the display position of the question 1 is changed, serial numbers of N questions in the questionnaire form may be resequenced in a new sequence from top to bottom, thereby obtaining an updated questionnaire form.

The foregoing process of adjusting the display position of the question may refer to FIG. 11d. As shown in FIG. 11d, if the question 3 in the questionnaire form needs to be adjusted to the question 4, the question 3 (or any position in a display region occupied by the question 3) may be triggered to change the question 3 to the movable state. Then, the question 3 is moved from an original display position (that is, the first display position) to a display region after the question 4, and is released. In this case, the question 3 may be placed after the question 4 and before the question 5. When the question 3 is successfully placed after the question 4 and before the question 5, the serial number 4 of the question 4 is changed to the serial number 3, and the serial number 3 of the question 3 is changed to the serial number 4.

In summary, in embodiments of this disclosure, the creator may perform the correction operation on the questionnaire form as required after generating the questionnaire form according to the text content. In this way, a limitation that the questionnaire form may be generated only by using the text content in the import window is broken, methods for creating the questionnaire form are enriched, the finally obtained questionnaire form may meet the requirement of the creator better, and the quality of the questionnaire form is improved.

In embodiments of this disclosure, the import window may be displayed in response to the import trigger event, the text content required to create the questionnaire form is entered in the import window, and then the questionnaire form including the N questions is automatically created according to the text content. In the foregoing solution, the questionnaire form may be automatically created by entering the text content required to create the questionnaire form in the import window, so that the questionnaire form may be created more simply and conveniently. In addition, the continuous text content is automatically split into the N questions, so that questionnaire form creation intelligence and efficiency are improved. Moreover, the collaborative editing object may be added to implement multi-person collaborative editing of the text content or the questionnaire form, thereby meeting a requirement for multi-person collaborative editing of the questionnaire form.

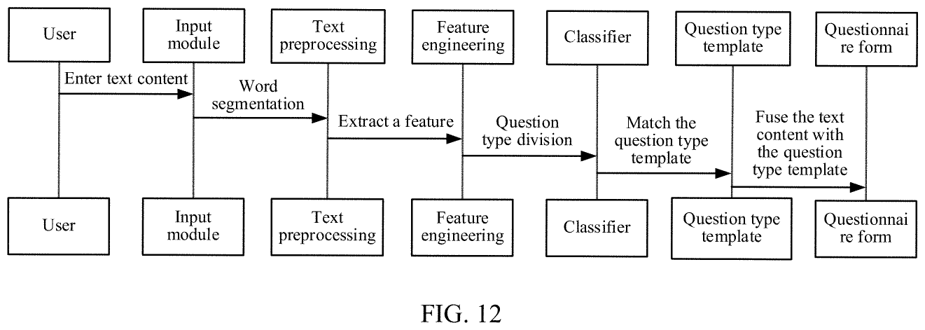

The foregoing embodiments describe an overall solution process of the form generation method provided in embodiments of this disclosure. The following describes in further detail an overall implementation process of some embodiments of this disclosure. The following first describes the overall process of the form generation method in combination with a timing diagram shown in FIG. 12, to help understand the overall process implemented in background. As shown in FIG. 12, first, the creator may enter text content in the import window. The text content is a character string text, that is, a text including a plurality of character strings. Each character string includes a plurality of characters. One character string corresponds to one question. Then, text preprocessing is performed on the text content to implement word segmentation of the text content. Next, feature information of each phrase (that is, a character string including one or more characters) obtained by word segmentation is extracted, and a feature vector of each character string is obtained based on the feature information. Later on, a question type and a question type template corresponding to the question type are allocated to each character string according to the feature vector. Finally, fusion processing is performed on each character string and the corresponding question type template to obtain a question corresponding to each character string, thereby successfully creating a questionnaire form.

For example, the text content entered by the creator in the import window is “ [symbol] (Name of student)”. The text content includes a character string. The character string includes a character “ [symbol] ”, a character “ [symbol] ”, a character “ [symbol] ”, a character “ [symbol] ”, and a character “ [symbol] ” Text preprocessing is performed on the text content to obtain phrases “ [symbol] ”, “ [symbol] ”, and “ [symbol] ”. Feature information of the three phrases is extracted, and a feature vector of the text content is generated based on the feature information. The feature vector is input to a classifier for question type matching. The classifier may output a matching result. The matching result indicates that a combination of the phrases “ [symbol] ” and “ [symbol] ” belongs to the completion question type. In this case, a question type template corresponding to the completion question type is pulled, and a question type enumeration value corresponding to the completion question type (that is, data of the question type template corresponding to the completion question type). Then, the text content is fused with the question type template to obtain a question. The question is inserted into the questionnaire form, thereby successfully creating the questionnaire form.

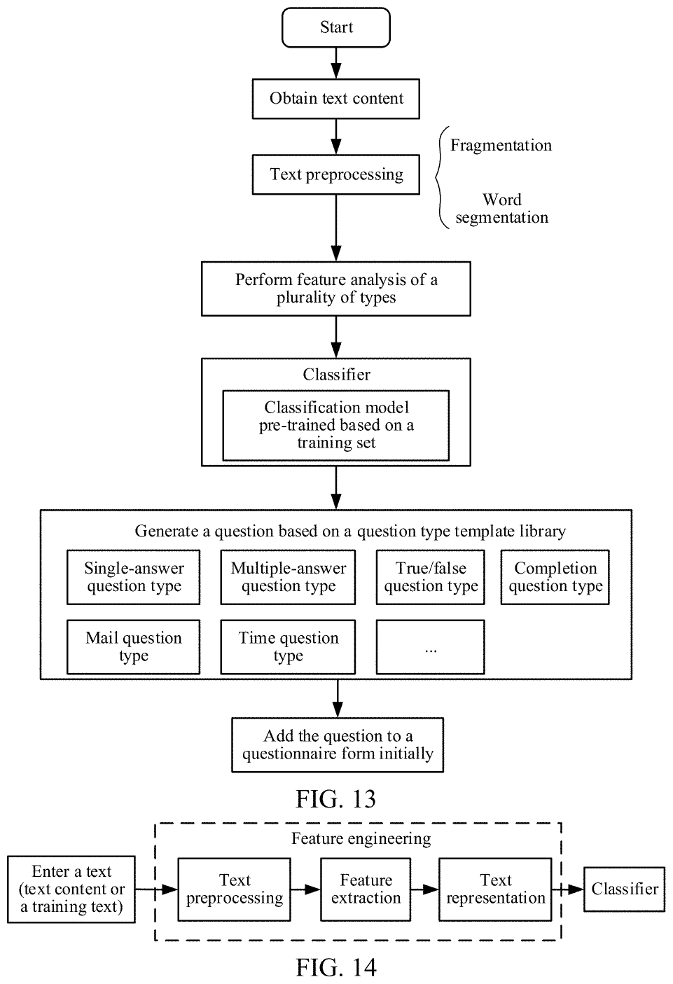

The following describes each step in the timing diagram shown in FIG. 12 in more detail in combination with a schematic flowchart of a form generation method performed by a target terminal in FIG. 13. It can be seen from the flowchart shown in FIG. 13 that a core algorithm in this embodiment of this disclosure is text classification, and then the question is intelligently generated based on the question type obtained by classifying the text content (or a text fragment in the text content) in combination with the preset question type template. FIG. 14 is an exemplary schematic architectural diagram of a text classification system. As shown in FIG. 14, the classification system first performs text preprocessing on an entered text (for example, to-be-classified text content, or a training text for training a classification model), then performs text representation on a phrase set obtained by text preprocessing to obtain a feature vector, and then inputs the feature vector to a classifier to obtain a classification result of the text (that is, a question type result, or referred to as a question type for short). Based on this, a process of the form generation method may generally include steps s11-s16 (not shown):

In step s11, obtain text content. The text content is entered by the creator or a collaborative editing object in an import window. The text content may include at least one text fragment. The text fragment may refer to the above-described character string. One text fragment corresponds to one question.

In step s12, perform text preprocessing on the text content. Text preprocessing may be understood as a process of extracting a keyword from the text content to represent the text. Text preprocessing mentioned in this embodiment of this disclosure may include fragmentation and word segmentation. (1) Performing fragmentation on the text content refers to splitting the text content to obtain N text fragments in the text content, N being an integer greater than 1. A principle of splitting the text content may include but is not limited to splitting the text content according to semantics of the text content, splitting the text content according to an identifier, or the like. Splitting the text content according to the semantics may refer to analyzing semantic information of the text content, and punctuating content in the text content according to the semantic information, thereby splitting the text content into the N text fragments corresponding to N kinds of semantics. A common semantic analysis method may include but is not limited to dependency parsing (DP), semantic dependency parsing (SDP), part-of-speech relationship analysis, and so on. Splitting the text content according to the identifier may refer to detecting a position of the identifier in the text content, determining the position of the identifier as a fragmentation position, and splitting the text content into a plurality of text fragments according to the fragmentation position. For example, if the text content includes N−1 identifiers, it is determined that the text content may be split into the N text fragments according to the N−1 identifiers. The identifier may be preset by a manager according to a service requirement. The identifier may include but is not limited to a link breaker, a space character, a full stop, a fragmentation character (for example, a character specially for distinguishing between different text fragments), and the like. Fragmentation may be performed first on the text content to split the text content into fragments respectively corresponding to N questions, and each fragment may be processed subsequently to obtain the corresponding question. Therefore, complexity in question generation can be reduced, a processing speed of the target terminal can be increased, and accuracy of the question finally generated by the target terminal can be improved.

(2) Performing word segmentation on the text content may refer to performing word segmentation on the N text fragments in the text content respectively to obtain a candidate phrase set corresponding to each text fragment. Any candidate phrase set includes at least one phrase. The phrase herein may be a character string including one or more characters. For example, the phrase “ [symbol] ” includes the character “ [symbol] ” and the character “ [symbol] ”. A phrase “ [symbol] (is)” includes only a character “ [symbol] (is)”. Performing word segmentation on each text fragment may further include a word segmentation stage and a stop word removal stage.

(2-1) A word segmentation stage is a stage in which the text fragment is split to obtain each phrase in the text fragment. For example, if content of the text fragment is “ [symbol] (Name of student)”, word segmentation may be performed on the text content to obtain a phrase “ [symbol] ”, a phrase “ [symbol] ”, and a phrase “ [symbol] ”, that is, a candidate phrase set corresponding to the text fragment “ [symbol] (Name of student)” includes the phrases “ [symbol] ”, “ [symbol] ”, and “ [symbol] ”. A common word segmentation algorithm may include but is not limited to a statistics-based word segmentation method, a rule-based word segmentation method, a dictionary-based word segmentation method, and the like. Description is made in this embodiment of this disclosure by using an example in which word segmentation is performed on the text content by using the statistics-based word segmentation method. Word segmentation is statistically considered as a probability maximization issue. In an example, statistics on a probability of occurrence of a phrase formed by adjacent characters in the text fragment may be collected based on a corpus. A greater quantity of occurrences of the phrase formed by the adjacent characters indicates that the phrase formed by the adjacent characters is more common. For example, if the text fragment is “ [symbol] (Name of student)”, it may be statistically obtained based on the corpus that a quantity of occurrences of the phrase “ [symbol] ” formed by the adjacent characters “ [symbol] ” and “ [symbol] ” is greater than that of a phrase “ [symbol] ” formed by the adjacent characters “ [symbol] ” and “ [symbol] ”, that is, it is determined that “ [symbol] ”forms a phrase at a greater probability. In summary, the statistics-based word segmentation method is substantially performing word segmentation according to a probability value.

(2-2) The stop word removal stage is a stage in which stop word removal is performed on the candidate phrase set, obtained in the word segmentation stage, of the text fragment to obtain a phrase set of the text fragment, that is, a stop word in the candidate phrase set is removed. In an example, a stop word list may be obtained. The stop word list includes a plurality of stop words. The stop word may refer to a meaningless word, that is, a word that does not affect semantics of the text fragment. The stop word may include but is not limited to “de”, “la”, “ah”, “ba”, “hah”, and other words. Whether there is a stop word existing in both the candidate phrase set and the stop word list is detected. If there is a stop word existing in both the candidate phrase set and the stop word list, the stop word existing in both the candidate phrase set and the stop word list is detected from the candidate phrase set, such that an updated phrase set does not include the stop word. By stop word removal, meaningless words in the candidate phrase set may be removed, and feature extraction does not need to be performed on the meaningless words. Therefore, efficiency of subsequent feature analysis on the text fragment is improved, and processing pressure of the target terminal is reduced.

After the foregoing word segmentation step is performed on the N text fragments in the text content, a candidate phrase set of each text fragment may be obtained. Then, stop word removal is performed on the candidate phrase set to obtain a phrase set of each text fragment. The phrase set of any text fragment includes no stop words. Therefore, subsequent steps are performed based on the phrase set including no stop words, which can improve question type division accuracy.

In step s13, perform feature analysis on the text content. A process of performing feature analysis on the text content is substantially a process of performing text representation on the text content, that is, a representation process of translating the text fragment into a computer understanding. In an example, a feature vector of each text fragment is generated according to the phrase set corresponding to each text fragment. Feature extraction may be performed on each phrase in the phrase sets corresponding to the N text fragments in the text content to generate an element for describing a feature of each phrase, thereby obtaining vector data (that is, the feature vector) for describing the feature of the text fragment.

A text representation algorithm may include but is not limited to a Boolean model, a vector space model (VSM), a latent semantic analysis model, a probability model, and the like. Description is made in this embodiment of this disclosure by using the VSM as an example. The VSM considers the text fragment as a phrase set. If the phrase set includes M phrases, the text fragment may be represented as an M-dimensional feature vector. Each element in the feature vector corresponds to a phrase. An element value of each element indicates a weight value of the phrase corresponding to the element in the text fragment. The weight value represents importance of the phrase in the text fragment to some extent. The weight value of each phrase may be calculated by using a feature weighting algorithm. A common feature weighting algorithm may include but is not limited to Boolean weighting, word frequency weighting, weighting, entropy weighting, and other algorithms.

During text processing, word segmentation is usually performed on any text fragment by collecting statistics on a phrase in the text fragment and a corresponding word frequency, and then merging the phrase in the text fragment into a phrase set. Therefore, the phrase set includes many different phrases. This makes the text feature represented by the feature vector of the text fragment very sparse, and increases time complexity and space complexity of a classification algorithm. In addition, inaccurate text feature representation seriously affects text classification performance. Based on this, the VSM supports reduction of dimensions of the feature vector through feature selection. A common text feature selection method may include but is not limited to a document frequency (DF)-based feature extraction method, an information gain (IG) method, χ2 (Chi-squared (CHI)) statistics, a mutual information method, and the like.

In step s14, determine a question type of the text content based on the feature vector of the text content.

After each text fragment is represented as the feature vector (or vector data) that a model may process, classification processing may be performed on the feature vector by using a machine learning model, so as to divide a question type that matches each text fragment. A common classification model (or machine learning model for classification) may include but is not limited to a naive Bayes algorithm, a K-nearest neighbor algorithm, a linear regression algorithm, a decision algorithm, and the like. In this embodiment of this disclosure, a data volume of the text content that needs to be processed is not so large, and complex semantic understanding is not needed. Therefore, the naive Bayes algorithm is used as the classifier for classifying the text fragment in this embodiment of this disclosure. The naive Bayes algorithm focuses on a probability that a phrase belongs to a specific type. When a probability that a phrase in a text fragment belongs to a specific type is higher than that of belonging to another type, it may be determined that a question type of the text fragment is a question type corresponding to the type corresponding to the highest probability. A probability that a phrase belongs to a question type corresponding to a specific type is equal to a comprehensive expression of a probability that each word in the phrase belongs to the type. The comprehensive expression may be obtained by calculating, according to a preset rule, the probability that each word belongs to the type. The preset rule may include but is not limited to an averaging rule, different weight ratios, and the like. The probability that each word in the phrase belongs to the type may be estimated to some extent by using a quantity of occurrences (that is, word frequency information) of the word in a training text corresponding to the type. Based on the above description, the naive Bayes algorithm is used to process the feature vector, so that an entire classification process is simpler and more feasible. On one hand, the processing speed of the target terminal can be increased. On the other hand, complex calculation can be avoided greatly, thereby reducing occupation of processing resources of the target terminal.

The following describes an exemplary implementation of processing the feature vector by using the naive Bayes algorithm by using an example in which the N text fragments in the text content include a target text fragment, the target text fragment is any one of the N text fragments, and a form editing interface supports S question types, S being an integer greater than 1. First, a training text of each of the S question types is obtained. Any training text includes a plurality of configuration words belonging to the same question type. S is an integer greater than 1. Then, S probability values that the target text fragment belong to the S question types are calculated respectively according to the training text of each question type. Finally, the question type corresponding to a maximum probability value in the S probability values is determined as a question type that matches the target text fragment.

For example, it is assumed that S=4, that is, there are four question types. In this case, a training text of each question type is obtained, for example, a training text 1 of a question type 1, a training text 2 of a question type 2, a training text 3 of a question type 3, and a training text 4 of a question type 4. Each training text includes at least one configuration word belonging to the question type corresponding to the training text. For example, if the question type 1 is a true/false question type, the training text 2 includes at least one configuration word belonging to the true/false question type (for example, whether, or judge). If probability values that the target text fragment belongs to various question types, calculated according to the training text of each question type, are respectively as follows: the probability value of belonging to the question type 1 is 40%, the probability value of belonging to the question type 2 is 50%, the probability value of belonging to the question type 3 is 20%, and the probability value of belonging to the question type 4 is 60%, the probability value that the target text fragment belongs to the question type 4 is greater than those of belonging to the other question types (for example, the question type 1, the question type 2, and the question type 3). In this case, the question type that matches the target text fragment is the question type 4.

The following describes an implementation of calculating the S probability values that the target text fragment belong to the S question types respectively according to the training text of each question type by using an example in which the phrase set corresponding to the target text fragment includes Q target phrases, Q being a positive integer, the target word includes at least one character, the S question types include a target question type, and the target question type corresponds to a target training text. First, statistics on word frequency information of occurrence of each character in each target phrase in the target training text is collected. Then, calculation is performed on the word frequency information of each character in each target phrase to obtain a probability value that each target phrase belongs to the target question type. Finally, a probability value that the target text fragment belongs to the target question type is obtained according to the Q probability values that the Q target phrases belong to the target question type.

For example, it is assumed that the phrase set corresponding to the target text fragment includes a target phrase 1 “ [symbol] ” and a target phrase 2 “ [symbol] ”. The target phrase 1 includes a word “ [symbol] ” and a word “ [symbol] ”. The target phrase 2 includes a word “ [symbol] ” and a word “ [symbol] ”. It is statistically obtained that word frequency information of occurrence of the word “ [symbol] ” in the target phrase 1 in the target training text is 5 and word frequency information of occurrence of the word “ [symbol] ” in the target phrase 1 in the target training text is 5. Calculation is performed on the word frequency information of each word in the target phrase 1 according to the preset rule of averaging to obtain that a probability value that the target phrase 1 belongs to the target question type is (5+5)/2* %=50%. Similarly, for the target phrase 2, a probability value (assumed to be 60%) that the target phrase 2 belongs to the target question type is obtained by calculation according to the foregoing step. Then, the probability value that the target text fragment belongs to the target question type is obtained according to the probability value 50% that the target phrase 1 belongs to the target question type and the probability value 60% that the target phrase 2 belongs to the target question type. It is to be noted that a manner in which the probability value that the target text fragment belongs to the target question type is calculated based on probability values of a plurality of target phrases may be the same as a manner in which the target phrase belongs to the target question type is calculated based on a plurality of words, and will not be elaborated herein.

In step s15, perform fusion processing on the text content and a question type template corresponding to the question type to generate a question. The question type template is from a question type template library. The question type template may be a preset set of question data types, and includes a preset question form and basic data information. A stem of the question type template is fused with content of a text fragment belonging to the question type to obtain a question of the question type.

In step s16, ddd the question to a questionnaire form initially. The foregoing operation is performed on the N text fragments obtained by splitting the text content to obtain N questions corresponding to the N text fragments. The N questions are added to the questionnaire form. In this way, the questionnaire form is successfully created.

In summary, in an embodiment of this disclosure, text preprocessing may be performed on the obtained text content to obtain the phrase sets of the N text fragments in the text content. Then, the feature vector of each text fragment is generated based on the phrase set of each text fragment. Next, the question type is matched for each text fragment based on the feature vector of each text fragment. Finally, fusion processing is performed on each text fragment and the question type template of the corresponding question type to generate the question in the questionnaire form. In the foregoing process, a plurality of questions may be automatically generated according to the text content entered by the creator, and for each question, the corresponding question type is matched and answer options are added. In this way, questionnaire form creation efficiency is improved, and the questionnaire form may be generated intelligently.

The following provides an exemplary apparatus of embodiments of this disclosure, for ease of implementing the foregoing solution of embodiments of this disclosure better.

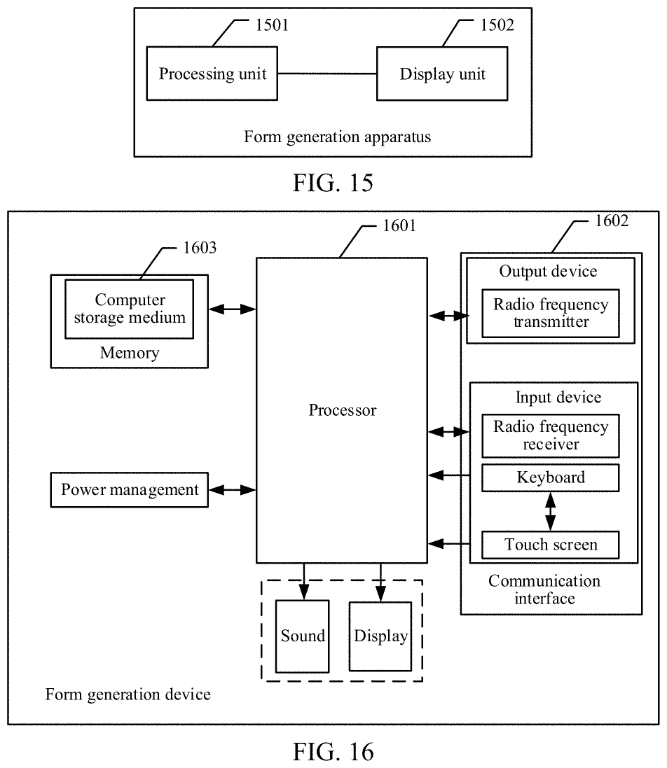

FIG. 15 is a schematic structural diagram of a form generation apparatus according to some embodiments of this disclosure. The form generation apparatus may be a computer program (including a program code) running in a target terminal. For example, the form generation apparatus may be an application program (for example, Tencent Docs) in the target terminal. The form generation apparatus may be configured to perform some or all steps in the method embodiments shown in FIG. 2, FIG. 9, and FIG. 13. Referring to FIG. 15, the form generation apparatus may include a processing unit 1501 and a display unit 1502. One or more modules, submodules, and/or units of the apparatus can be implemented by processing circuitry, software, or a combination thereof, for example.

The processing unit 1501 is configured to display an import window in response to detecting an import trigger event in a form editing interface, the form editing interface being used for creating a questionnaire form, the import window being used for importing text content for creating the questionnaire form. The processing unit 1501 is further configured to obtain the text content that is imported through the import window and that is used for creating the questionnaire form. The processing unit 1501 is further configured to create the questionnaire form according to the text content, the questionnaire form including N questions, the N questions being obtained by performing parsing processing on the text content, and N being an integer greater than 1. The display unit 1502 is configured to display the questionnaire form.

In an implementation mode, the import entry is set in the form editing interface. The import trigger event is generated in a case that the import entry is selected.

In an implementation, the import trigger event is generated in a case that the import trigger operation is detected in the form editing interface.

The import trigger operation includes at least one of the following: a gesture operation, an audio signal input operation, and a vibration operation.

In an implementation, an input control is set in the import window. The processing unit 1501, when configured to obtain the text content that is imported through the import window and that is used for creating the questionnaire form, is specifically configured to invoke the input control, and receive the text content that is entered in the import window through the input control.

In an implementation, the text content is in a document. The processing unit 1501, when configured to obtain the text content that is imported through the import window and that is used for creating the questionnaire form, is specifically configured to copy, in a case that the target terminal opens and displays the document, the text content from the document, and paste the copied text content into the import window.

In an implementation, the text content is in a document. The processing unit 1501, when configured to obtain the text content that is imported through the import window and that is used for creating the questionnaire form, is specifically configured to: load the document into the import window in response to any of the following operations.

The operations include at least one of the following: a dragging operation of dragging the document into the import window, a trigger operation on an import control, a gesture operation in the import window, and acquisition of an audio signal for instructing the document to be imported into the import window.

In an implementation, the processing unit 1501 is further configured to:

display an object list in response to detecting a collaborative editing trigger operation on the text content, the object list including an identifier of at least one collaborative editing object;

select one or more identifiers from the object list, and transmit the text content in the import window to the selected collaborative editing object for collaborative editing; and

update the text content in the import window according to a collaborative editing result.

In an implementation, the processing unit 1501 is further configured to:

display an object list in response to detecting a collaborative editing trigger operation on the questionnaire form, the object list including an identifier of at least one collaborative editing object;

select one or more identifiers from the object list, and transmit the questionnaire form to the selected collaborative editing object for collaborative editing; and

update the questionnaire form according to a collaborative editing result.

In an implementation, the N questions in the questionnaire form are questions of the same question type, or are questions of different question types.

In an implementation, the processing unit 1501 is further configured to update the questionnaire form according to a correction operation on the question in the questionnaire form.

The correction operation includes at least one of the following: increasing or decreasing a quantity of questions in the questionnaire form, modifying a question type of the question in the questionnaire form, and adjusting a display position of the question in the questionnaire form.

In an implementation, the correction operation includes increasing the quantity of questions in the questionnaire form. The form editing interface includes a component center region. The component center region includes at least one candidate component. One candidate component corresponds to one question type template. The processing unit 1501 is further configured to:

select a target component from the component center region according to a component selection operation, the target component being any one of the at least one candidate component;

add a target question type template corresponding to the target component to the questionnaire form; and

update the questionnaire form according to a question editing operation on the target question type template, an updated questionnaire form including a target question obtained after the question editing operation is performed on the target question type template.

The component selection operation includes at least one of the following: a dragging operation of dragging the target component from the component center region to the questionnaire form, or a trigger operation performed on the target component in the component center region.

In an implementation, the form editing interface includes a preview control. The display unit 1502, when configured to display the questionnaire form, is specifically configured to display a preview interface in a case that the preview control is selected, and display the questionnaire form in the preview interface.

In an implementation, the form editing interface includes a publishing option. The processing unit 1501 is further configured to publish the questionnaire form in a case that there is a selection operation on the publication option.

In an implementation, the processing unit 1501, when configured to create the questionnaire form according to the text content, is specifically configured to:

split the text content to obtain N text fragments, one text fragment corresponding to one question;

perform word segmentation on the N text fragments respectively to obtain a phrase set corresponding to each text fragment, any phrase set including at least one phrase;

generate a feature vector of each text fragment according to the phrase set corresponding to each text fragment;

determine a question type corresponding to each text fragment based on the feature vector of each text fragment, and obtain a question type template corresponding to the question type corresponding to each text fragment; and

perform fusion processing on each text fragment and the obtained corresponding question type template to generate the questionnaire form.

In an implementation, the form editing interface supports S question types, S being an integer greater than 1. The N text fragments include a target text fragment. The target text fragment is any one of the N text fragments.

The processing unit 1501, when configured to determine the question type corresponding to each text fragment based on the feature vector, is specifically configured to:

obtain a training text of each of the S question types;

calculate, according to the training text of each question type, probability values that the target text fragment belong to the S question types respectively to obtain S probability values; and

determine the question type corresponding to a maximum probability value in the S probability values as a question type that matches the target text fragment.

In an implementation, the phrase set corresponding to the target text fragment includes Q target phrases, Q being a positive integer. The target phrase includes at least one character.

That the processing unit 1501 is configured to calculate, according to the training text of each question type, probability values that the target text fragment belong to the S question types respectively to obtain S probability values includes:

for the training text of each question type:

collecting statistics on word frequency information of occurrence of each character in each target phrase in the target training text;

performing calculation on the word frequency information of each character in each target phrase to obtain a probability value that each target phrase belongs to the question type; and

obtaining, according to the Q probability values that the Q target phrases belong to the question type, the probability value that the target text fragment belongs to the question type.

According to some embodiments of this disclosure, each unit in the form generation apparatus shown in FIG. 15 may exist respectively or be combined into one or more other units. Alternatively, a certain (or some) unit in the units may be further split into multiple smaller function units, thereby implementing the same operations without affecting the technical effects of embodiments of this disclosure. The units are divided based on logical functions. In actual applications, a function of one unit may be realized by multiple units, or functions of multiple units may be realized by one unit. In another embodiment of this disclosure, the form generation apparatus may further include other units. In actual applications, these functions may also be realized cooperatively by the other units, and may be realized cooperatively by multiple units. According to another embodiment of this disclosure, a computer program (including a program code) capable of performing each step involved in the corresponding methods shown in FIG. 2, FIG. 9, and FIG. 13 may be run in a general-purpose computing device, for example, a computer, including a processing element (such as processing circuitry) and a storage element, for example, a central processing unit (CPU), a random access memory (RAM), or a read-only memory (ROM), to structure the form generation apparatus shown in FIG. 15 and implement the form generation method in embodiments of this disclosure. The computer program may be recorded in, for example, a computer-readable recording medium and loaded, through the computer-readable recording medium, and run in the computing device.

In an embodiment of this disclosure, the processing unit 1501 may display the import window in response to the import trigger event, enter, in the import window, the text content required to create the questionnaire form, and then automatically create the questionnaire form including the N questions according to the text content. In the foregoing solution, the questionnaire form may be automatically created by entering the text content required to create the questionnaire form in the import window, so that the questionnaire form may be created simply and conveniently. In addition, the continuous text content is automatically split into the N questions, so that questionnaire form creation intelligence and efficiency are improved. Moreover, the collaborative editing object may be added to implement multi-person collaborative editing of the text content or the questionnaire form, thereby meeting a requirement for multi-person collaborative editing of the questionnaire form.

FIG. 16 is a schematic structural diagram of a terminal according to some embodiments of this disclosure. Referring to FIG. 16, the terminal includes processing circuitry (such as a processor 1601), a communication interface 1602, and a computer-readable storage medium 1103. The processor 1601, the communication interface 1602, and the computer-readable storage medium 1603 may be connected through a bus or in another manner. The communication interface 1602 is configured to receive and send data. The computer-readable storage medium 1603 may be stored in a memory of the terminal. The computer-readable storage medium 1603 is configured to store a computer program. The computer program includes a program instruction. The processor 1601 is configured to execute the program instruction stored in the computer-readable storage medium 1603. As a computing core or control core of the terminal, the processor 1601 (or referred to as a CPU) is suitable for implementing one or more instructions, specifically suitable for loading and executing one or more instructions, thereby implementing corresponding method processes or corresponding functions.

An embodiment of this disclosure also provides a computer-readable storage medium (memory), such as a non-transitory computer-readable storage medium. As a memory device in the terminal, the computer-readable storage medium is configured to store a program and data. It may be understood that the computer-readable storage medium herein may include a built-in storage medium in the terminal, or may include an extended storage medium supported by the terminal. The computer-readable storage medium provides a storage space that stores a processing system of a form generation device. Moreover, one or more instructions suitable for the processor 1601 to load and execute are also stored in the storage space, and these instructions may be one or more computer programs (including program codes). It is to be noted that the computer-readable storage medium herein may be a high-speed RAM, or a non-volatile memory, for example, at least one disk memory. In an example, the computer-readable storage medium may be at least one computer-readable storage medium away from the processor.

In an embodiment, the terminal may be the target terminal mentioned in the foregoing embodiments. One or more instructions are stored in the computer-readable storage medium. The processor 1601 loads and executes the one or more instructions stored in the computer-readable storage medium, so as to implement the corresponding steps in the embodiment of the form generation method.

An embodiment of this disclosure also provides a computer program product or computer program. The computer program product or computer program includes a computer instruction. The computer instruction is stored in a computer-readable storage medium. A processor of a form generation device reads the computer instruction from the computer-readable storage medium. The processor executes the computer instruction, such that the form generation device performs the form generation method.

The units and algorithm steps of each example described in combination with embodiments disclosed in this disclosure may be implemented by electronic hardware or a combination of computer software and electronic hardware. Whether these functions are executed by hardware or software depends on specific applications and design constraints of the technical solutions. Different methods may be used to implement the described functions for each particular application, but it is not to be considered that such implementation goes beyond the scope of this disclosure.

All or some of the foregoing embodiments may be implemented by using software, hardware, firmware, or any combination thereof. When software is used to implement embodiments, all or some of the embodiments may be implemented in a form of a computer program product. The computer program product includes one or more computer instructions. When the computer program instructions are loaded and executed on the computer, the processes or functions according to embodiments of this disclosure are all or partially generated. The computer may be a general-purpose computer, a dedicated computer, a computer network, or another programmable device. The computer instruction may be stored in a computer-readable storage medium or transmitted through the computer-readable storage medium. The computer instruction may be transmitted from one website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a digital video disk (DVD)), a semiconductor medium (for example, a solid state disk (SSD)), or the like.

The foregoing descriptions are only exemplary implementations of this disclosure, and are not intended to limit the scope of this disclosure. Other embodiments shall fall within the scope of this disclosure.

What is claimed is:

1. A form generation method, comprising:
displaying a text entry interface, the text entry interface being configured to receive text content of a plurality of questions to be included in a questionnaire form;
receiving the text content of the plurality of questions to be included in the questionnaire form and entered in the text entry interface;
generating the questionnaire form according to the text content, the questionnaire form including a plurality of questions that are determined based on parsing of the text content; and
displaying the questionnaire form.

2. The form generation method according to claim 1, wherein the text content of the plurality of questions is received in a single data field of the text entry interface.

3. The form generation method according to claim 1, wherein the generating the questionnaire form comprises:
determining an answer format type for each of the plurality of questions in the questionnaire form; and
generating the questionnaire to include the answer format types corresponding to the plurality of questions.

4. The form generation method according to claim 1, wherein the generating the questionnaire form comprises:
dividing the text content into a plurality of text fragments, each of the plurality of text fragments corresponding to one question;
determining a phrase set of each of the plurality of text fragments based on word segmentation of the plurality of text fragments, each phrase set including at least one phrase;
generating a feature vector of each of the plurality of text fragments according to the phrase set corresponding to the respective text fragment;
determining a question type of each of the plurality of text fragments based on the feature vector of the respective text fragment, and obtaining a question type template corresponding to the question type corresponding to the respective text fragment; and
generating the questionnaire form based on each of the plurality of text fragments and the obtained corresponding question type templates.

5. The form generation method according to claim 4, wherein
the determining the question type corresponding to each of the plurality of text fragments comprises:
obtaining a training text of each of a plurality of question types;
determining a plurality of probability values, according to the training text of each of the plurality of question types, that a target text fragment of the plurality of text fragments belongs to the plurality of question types respectively; and
determining the question type corresponding to a maximum probability value in the plurality of probability values as corresponding to the target text fragment.

6. The form generation method according to claim 5, wherein the phrase set corresponding to the target text fragment comprises Q target phrases, Q being a positive integer, and the target phrase comprises at least one character, wherein
the determining the plurality of probability values comprises:
for the training text of each question type:
collecting statistics on word frequency information of occurrence of each character in each target phrase in the training text;
determining a probability value that each target phrase belongs to the question type based on the word frequency information of each character in each target phrase; and
determining, according to the plurality of probability values that the plurality of target phrases belong to the question type, the probability value that the target text fragment belongs to the question type.

7. The form generation method according to claim 1, wherein the text entry interface is displayed based on a user selection of a first graphical element that is associated with the text entry interface.

8. The form generation method according to claim 1, wherein
the text entry interface is displayed based on at least one of a predetermined gesture operation, a predetermined audio signal input operation, or a predetermined vibration operation.

9. The form generation method according to claim 1, wherein the receiving the text content comprises:
receiving the text content that is manually entered in the in the text entry interface.

10. The form generation method according to claim 1, wherein the receiving the text content comprises:
receiving the text content that is copied from another document and pasted into the text entry interface.

11. The form generation method according to claim 1, wherein the receiving the text content comprises:
copying the text content from another document based on an import document instruction.

12. The form generation method according to claim 1, further comprising:
displaying an object list based on a collaborative editing operation on the text content, the object list including an identifier of at least one collaborative editing object;
selecting one or more identifiers from the object list, and providing the text content in the text entry interface to the selected collaborative editing object for collaborative editing; and
updating the text content in the text entry interface according to the collaborative editing.

13. The form generation method according to claim 1, further comprising:
displaying an object list based on a collaborative editing operation on the questionnaire form, the object list including an identifier of at least one collaborative editing object;
selecting one or more identifiers from the object list, and providing the questionnaire form to the selected collaborative editing object for collaborative editing; and
updating the questionnaire form according to the collaborative editing.

14. The form generation method according to claim 1, further comprising:
at least one of increasing or decreasing a quantity of questions in the questionnaire form, modifying a question type of one of the plurality of questions in the questionnaire form, and adjusting a display position of the one of the plurality of questions in the questionnaire form based on user input.

15. The form generation method according to claim 1, further comprising:
adding a target question type template corresponding to the questionnaire form; and
updating the questionnaire form according to a question editing operation on the target question type template.

16. The form generation method according to claim 1, wherein the displaying the questionnaire form comprises:
displaying a preview interface based on a selection of a second graphical element associated with the preview interface, and
displaying the questionnaire form in the preview interface.

17. The form generation method according to claim 1, further comprising:
publishing the questionnaire form based on a user selection of a publication function.

18. An information processing apparatus, comprising:
processing circuitry configured to:
display a text entry interface, the text entry interface being configured to receive text content of a plurality of questions to be included in a questionnaire form;
receive the text content of the plurality of questions to be included in the questionnaire form and entered in the text entry interface;
generate the questionnaire form according to the text content, the questionnaire form including a plurality of questions that are determined based on parsing of the text content; and
display the questionnaire form.

19. The information processing apparatus according to claim 18, wherein the processing circuitry is configured to:
determine an answer format type for each of the plurality of questions in the questionnaire form; and
generate the questionnaire to include the answer format types corresponding to the plurality of questions.

20. A non-transitory computer-readable storage medium storing instructions which when executed by a processor cause the processor to perform:
displaying a text entry interface, the text entry interface being configured to receive text content of a plurality of questions to be included in a questionnaire form;
receiving the text content of the plurality of questions to be included in the questionnaire form and entered in the text entry interface;
generating the questionnaire form according to the text content, the questionnaire form including a plurality of questions that are determined based on parsing of the text content; and
displaying the questionnaire form.
